(19) United States
(12) Patent Application Publication
(10) Pub. No.: US 2018/0113925 A1
(43) Pub. Date: Apr. 26, 2018

(54) APPARATUS AND METHOD TO ANALYZE DEPENDENCY RELATIONSHIP BETWEEN REQUESTS FOR DATABASE OPERATIONS

(71) Applicant: FUJITSU LIMITED, Kawasaki-shi (JP)

(72) Inventor: Satoshi Munakata, Kawasaki (JP)

(73) Assignee: FUJITSU LIMITED, Kawasaki (JP)

(21) Appl. No.: 15/711,163

(22) Filed: Sep. 21, 2017

(30) Foreign Application Priority Data
Oct. 20, 2016 (JP) 2016-205820

(51) Int. Cl. G06F 17/30

(52) U.S. Cl. CPC G06F 17/30572; G06F 17/3005; G06F 17/30539

(57) ABSTRACT

An apparatus stores plural operation requests to be applied to a database sequentially and a first output result outputted when the plural operation requests are applied to the database. The apparatus selects a first operation request from among the plural operation requests, and acquires contents of the database before the first operation request is applied. The apparatus produces a second output result which is outputted when a series of operation requests to be applied after the first operation request are applied to the acquired contents of the database, and determines that when the first output result matches with the second output result, the first operation request does not relate to a second operation request which is applied last among the plural operation requests, where an operation request which does not relate to the second operation request in the series of operation requests is skipped when producing the second output result.

### CROSS-REFERENCE TO RELATED APPLICATION

This application is based upon and claims the benefit of priority of the prior Japanese Patent Application No. 2016-205820, filed on Oct. 20, 2016, the entire contents of which are incorporated herein by reference.

### FIELD

The embodiments discussed herein are related to apparatus and method to analyze dependency relationship between requests for database operations.

### BACKGROUND

Many Web applications have been widely used. Most Web applications use database systems on networks (relational database management systems (RDBMS), for example) to implement functions provided for users.

A Web application transmits to a database system, a hypertext transfer protocol (HTTP) request which requests an operation for a database, for example. The HTTP request includes information (HTTP meta data) corresponding to an SQL statement to be executed in the database system. The database system analyzes HTTP metadata of the received HTTP request and executes the SQL statement corresponding to the HTTP metadata.

For one HTTP request, at least one SQL statement is executed. Moreover, execution of an SQL statement to update the contents of the database (referred to as an update SQL statement) sometimes influences the results from executing another SQL statement to be executed after the update SQL statement. A series of HTTP requests transmitted from a Web application possibly includes a combination of HTTP requests that have such a relationship that the result from executing an SQL statement corresponding to one of the HTTP requests influences the result from executing the SQL statement of the other HTTP request, that is, include a plurality of HTTP requests relating to each other.

When a Web application is suspected to include any failure, such as when there is an improper output while the Web application is in use, failure may be included in any processing element concerning an operation for a database. When some of the HTTP requests are related, an error which has occurred during processing of one of the HTTP requests may propagate to processing of another HTTP request. Accordingly, it will be difficult to specify such failure as described above without analyzing the relationship between the HTTP requests.

For specifying the cause of performance failure concerning processing of HTTP requests, a method is proposed, which estimates the processing relationship between the HTTP requests and SQL statements. In this method, the relationship is estimated by associating an HTTP request with an SQL statement which is frequently processed in the RDBMS during processing of the HTTP request. Moreover, in order to reduce the number of computations, this method skips data in the period when a particular HTTP request is processed together with a lot of other HTTP requests and associates HTTP requests with SQL statements in the remaining data.

The related techniques are disclosed in, for example, International Publication Pamphlet No. WO 2014/174681.

### SUMMARY

According to an aspect of the invention, an apparatus stores a plurality of operation requests to be applied to a database sequentially and a first output result outputted when the plurality of operation requests are applied to the database. The apparatus selects a first operation request from among the plurality of operation requests, and acquires contents of the database before the first operation request is applied. The apparatus produces a second output result which is outputted when a series of operation requests to be applied after the first operation request of the plurality of operation requests are applied to the acquired contents of the database, and determines that when the first output result matches with the second output result, the first operation request does not relate to a second operation request which is applied last among the plurality of operation requests, where an operation request which does not relate to the second operation request in the series of operation requests is skipped when producing the second output result.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

The aforementioned method analyzes the relationship between HTTP requests and SQL statements. On the other hand, as a method of analyzing the relationship between HTTP requests, there is a method of confirming whether the result from executing each SQL statement corresponding to a certain HTTP request influences the results from executing SQL statements corresponding to the other HTTP requests. However, the process of selecting each HTTP request from a set of target HTTP requests and confirming the aforementioned influence of each SQL statement corresponding to the selected HTTP request produces a large processing burden.

It is preferable to reduce the processing load to extract the relationship between operation requests. HTTP requests to request execution of SQL statements are just an example of the operation requests.

FIG. 1 is a diagram illustrating an example of an information processing apparatus, according to an embodiment;

FIG. 2 is a diagram illustrating an example of a method of analyzing relationship between SQL statements, according to an embodiment;

FIG. 3 is a diagram illustrating an example of a system, according to an embodiment;

FIG. 4 is a diagram illustrating an example of a database, according to an embodiment;

FIG. 5 is a diagram illustrating an example of an operational sequence for a server apparatus and a client apparatus concerning operation for a database, according to an embodiment;

FIG. 6 is a diagram illustrating an example of an SQL log, according to an embodiment;

FIG. 7 is a diagram illustrating an example of a hardware configuration capable of implementing functions of an information processing apparatus, according to an embodiment;

FIG. 8 is a diagram illustrating an example of a functional configuration of an information processing apparatus, according to an embodiment;

FIG. 9 is a diagram illustrating an example of SQL log information, according to an embodiment;

FIG. 10 is a diagram illustrating an example of corresponding SQL information, according to an embodiment;

FIG. 11 is a diagram illustrating an example of reproduction target information, according to an embodiment;

FIG. 12 is a diagram illustrating an example of test result information, according to an embodiment;

FIG. 13 is a diagram illustrating an example of relationship information, according to an embodiment;

FIG. 14 is a diagram illustrating an example of a reproduction target selection screen, according to an embodiment;

FIG. 15 is a diagram illustrating an example of a reference producing method, according to an embodiment;

FIG. 16 is a diagram illustrating an example of a reference producing method, according to an embodiment;

FIG. 17 is a diagram illustrating an example of a reference producing method, according to an embodiment;

FIG. 18 is a diagram illustrating an example of a reference producing method, according to an embodiment;

FIG. 19 is a diagram illustrating an example of a reference producing method, according to an embodiment;

FIG. 20 is a diagram illustrating an example of a reference producing method, according to an embodiment;

FIG. 21 is a diagram illustrating an example of an analysis result display screen, according to an embodiment;

FIG. 22 is a diagram illustrating an example of an influence of separation of an update SQL statement on output, according to an embodiment;

FIG. 23 is a diagram illustrating an example of an operational flowchart for processing executed by an information processing apparatus, according to an embodiment;

FIG. 24 is a diagram illustrating an example of an operational flowchart for processing executed by an information processing apparatus, according to an embodiment; and

FIG. 25 is a diagram illustrating an example of an operational flowchart for processing executed by an information processing apparatus, according to an embodiment.

### DESCRIPTION OF EMBODIMENTS

Hereinafter, a description is given of embodiments of the disclosure with reference to the accompanying drawings. Some components including substantially identical functions are given the same reference numerals in the specification and drawings, and the overlapping description thereof is omitted in some cases.

### 1. First Embodiment

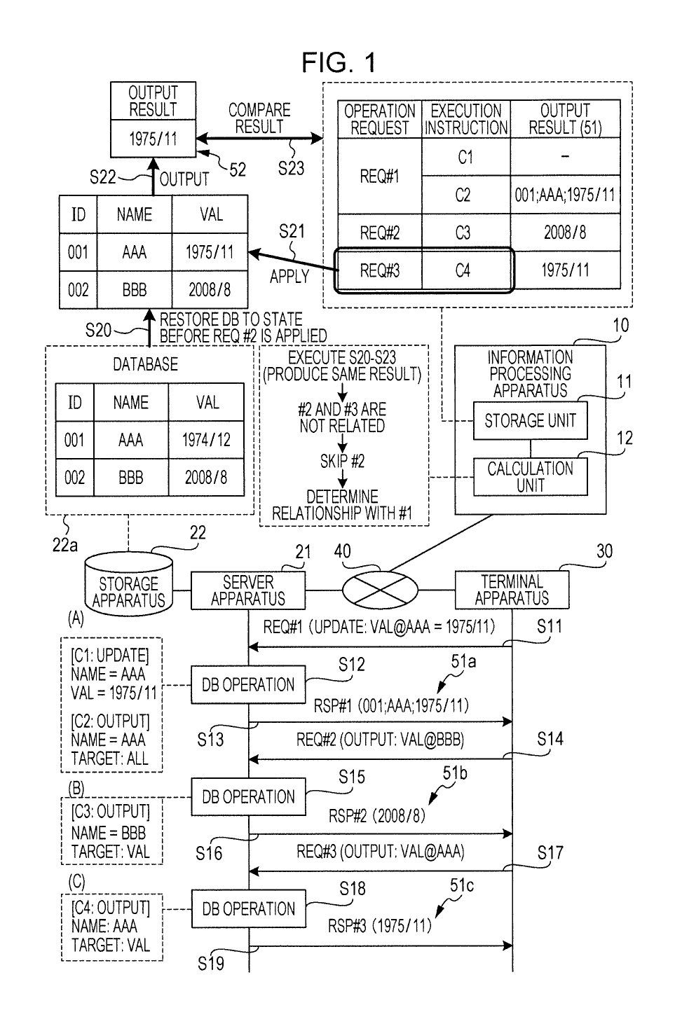

With reference to FIG. 1, a first embodiment is described. The first embodiment relates to a method of specifying an operation request relating to a certain one of a series of operation requests for a database. FIG. 1 is a diagram illustrating an example of an information processing apparatus according to the first embodiment. An information processing apparatus 10 illustrated in FIG. 1 is an example of the information processing apparatus according to the first embodiment.

As illustrated in FIG. 1, the information processing apparatus 10 includes a storage unit 11 and a calculation unit 12.

The storage unit 11 is a volatile storage device such as a random access memory (RAM) or a non-volatile storage device such as a hard disk drive (HDD) or a flash memory. The calculation unit 12 is a processor such as a central processing unit (CPU), a digital signal processor (DSP), an application specific integrated circuit (ASIC), or a field programmable gate array (FPGA). The calculation unit 12 executes a program stored in a storage unit 11 or another memory.

In the example of FIG. 1, the information processing apparatus 10 is coupled to a network 40 such as a local area network (LAN). The network 40 is coupled to a server apparatus 21 and a terminal apparatus 30. The server apparatus 21 is coupled to a storage apparatus 22 storing a database 22a.

The storage apparatus 22 is an HDD, a redundant arrays of inexpensive disks (RAID) device, or the like. The server apparatus 21 executes operations for the database 22a. The server apparatus 21 and storage apparatus 22 function as a database system such as a RDBMS, for example.

The terminal apparatus 30 is a computer that a user of the database 22a uses to access the server apparatus 21.

The terminal apparatus 30 transmits an operation request that requests the server apparatus 21 to operate the database 22a, for example. The operation request corresponds to at least a statement (an execution instruction) used to operate the database 22a. Examples of the execution instructions include SQL statements. Examples of operation requests include HTTP communications (HTTP requests) that request execution of SQL statements.

In the example of FIG. 1, the terminal apparatus 30 sequentially transmits plural operation requests (REQs #1, #2, and #3) to the server apparatus 21. The server apparatus 21 executes DB operations according to REQs #1, #2, and #3 received from the terminal apparatus 30 and transmits responses (RSPs #1, #2, and #3) to the terminal apparatus 30.

REQ #1 is an operation request that requests an update operation to rewrite the value of VAL to “1975/11” in a record with NAME=“AAA”. REQ #2 is an operation request that requests an output operation to output the value of VAL in a record with NAME=“BBB”. REQ #3 is an operation request that requests an output operation to output the value of VAL in a record with NAME=“AAA”.

The database 22a stores records with ID=001 and 002 before the DB operation according to REQ #1 is executed. In the record with ID=001, the NAME field is “AAA”, and the VAL field is “1974/12”. In the record with ID=002, the NAME field is “BBB”, and the VAL field is “2008/12”.

The terminal apparatus 30 transmits REQ #1 to the server apparatus 21 (S11). Upon receiving REQ #1, the server apparatus 21 executes a DB operation according to REQ #1 (S12). The operation of REQ #1 corresponds to statements C1 and C2, for example.

C1 is an execution instruction to specify the record with NAME=“AAA” in the database 22a and rewrite the value of VAL of the specified record to “1975/11”. C2 is an execution instruction to output the result from rewriting the record with NAME=“AAA” (whole of the record, for example).

The server apparatus 21 executes C1 and C2 in that order. The server apparatus 21 transmits the output result of the DB operation in S12 to the terminal apparatus 30 as a response RSP #1 to REQ #1 (S13). In this process, the server apparatus 21 transmits the output result (001; AAA; 1975/11) which is outputted by executing C2, to the terminal apparatus 30. (001; AAA; 1975/11) represents that the ID field is 001, the NAME field is “AAA”, and the VAL field is “1975/11”.

Next, the terminal apparatus 30 transmits REQ #2 to the server apparatus 21 (S14). Upon receiving REQ #2, the server apparatus 21 executes a DB operation according to REQ #2 (S15). The operation of REQ #2 corresponds to an execution instruction C3. C3 is an execution instruction to specify the record with NAME=“BBB” in the database 22a and output the value of VAL of the specified record. The server apparatus 21 executes C3 and acquires the output result (2008/8) from the database 22a. The server apparatus 21 then transmits the output result of the DB operation in S15, to the terminal apparatus 30 as response RSP #2 to REQ #2 (S16).

Next, the terminal apparatus 30 transmits REQ #3 to the server apparatus 21 (S17). Upon receiving REQ #3, the server apparatus 21 executes a DB operation according to REQ #3 (S18). The operation of REQ #3 corresponds to an execution instruction C4. C4 is an execution instruction to specify the record with NAME=“AAA” in the database 22a and output the value of VAL of the specified record.

The server apparatus 21 executes C4 to acquire the output result (1975/11) from the database 22a. The server apparatus 21 transmits the output result of the DB operation in S18, to the terminal apparatus 30 as response RSP #3 to REQ #3 (S19).

The information processing apparatus 10 analyzes the flow of the DB operations as described above and determines the relationship between a particular operation request and the other operation requests. In the example of FIG. 1, the particular operation request is REQ #3 which is applied to the database 22a last among REQs #1 #2, and #3. The information processing apparatus 10 analyzes the relationship between REQ #3 and REQs #1 and #2.

The storage unit 11 stores REQs #1, #2, and #3 which are to be sequentially applied to the database 22a and first output results 51 (outputs 51a, 51b, and 51c) which are outputted when REQs #1, #2, and #3 are applied to the database 22a, respectively. The storage unit 11 also stores operation requests and execution instructions to be executed according to the respective operation requests which are in relation to each other. The storage unit 11 stores: REQs #1 and C1 and C2 in relation to each other; REQs #2 and C3 in relation to each other; and REQs #3 and C4 in relation to each other, for example.

The calculation unit 12 selects a first operation request from REQs #1 and #2. The first operation request refers to an operation request which is an analysis target to be analyzed in terms of the relationship with REQ #3. As the first operation request, the calculation unit 12 selects operation requests in reverse to the order in which the operation requests are applied to the database 22a (in the order, #2 followed by #1), for example.

When REQ #2 is selected as the first operation request, the calculation unit 12 acquires the contents of the database 22a before REQ #2 is applied (after REQ #1 is applied) (S20: a process to restore the database 22a to the state before REQ #2 is applied). In the state before REQ #2 is applied, the value of VAL in the record with ID=001 is updated to “1975/11”.

The calculation unit 12 applies a series of operation requests (REQ #3) which are applied after the first operation request, to the contents acquired in S20 (S21) to produce a second output result 52 (S22). Specifically, in the process of S20 to S22, the calculation unit 12 skips REQ #2 selected as the first operation request from REQs #1, #2, and #3 and applies REQs #1 and #3 to the database 22a to produce an output result (a second output result 52). In this example, the second output result 52 is “1975/11” outputted by C4.

The calculation unit 12 compares the first output result 51 with the second output result 52 (S23). When the first output result 51 is the same as the second output result 52, the calculation unit 12 determines that the operation request applied last (the second operation request: REQ #3) does not relate to the first operation request (REQ #2).

In the example of FIG. 1, the first output result 51 (the output 51c corresponding to REQ #3 among the outputs 51a, 51b, and 51c) is the same as the second output result 52. The calculation unit 12 therefore determines that REQ #2 does not relate to REQ #3.

Next, the calculation unit 12 selects REQ #1 as the first operation request. The calculation unit 12 acquires the contents of the database 22a before REQ #1 is applied. In the state before REQ #1 is applied, the value of VAL in the record with ID=001 is “1974/12”.

The calculation unit 12 applies a series of operation requests (REQ #2 and #3) which are applied after the first operation request, to the acquired contents to produce the second output result 52. Specifically, the calculation unit 12 removes REQ #1 selected as the first operation request from REQs #1, #2, and #3 and produces an output result (the second output result 52) from applying REQs #2 and #3 to the database 22a. In the process of producing the second output result 52, the calculation unit 12 removes the operation request (REQ #2) which does not relate to the second operation request (REQ #3) from the series of operation requests (REQs #2 and #3).

When the calculation unit 12 produces the second output result 52 by selecting REQ #1 as the first operation request, the calculation unit 12 determines an output result obtained by applying REQ #3 to the contents of the database 22a before REQ #1 is applied, as the second output result 52.

Since applying REQ #2 does not influence the output result of REQ #3, skipping REQ #2 as described above does not influence the second output result 52. In this example, the second output result 52 is “1974/11” outputted by C4.

The calculation unit 12 compares the first output result 51 with the second output result 52. In this example, the first output result 51 (the output 51c corresponding to REQ #3 among the outputs 51a, 51b, and 51c) is different from the second output result 52. The calculation unit 12 therefore determines that REQ #1 relates to REQ #3. In the example of FIG. 1, the calculation unit 12 provides an analysis result that REQ #3 relates to REQ #1 while REQ #3 does not relate to REQ #2.

As described above, the relationship between a particular operation request and the other operation requests is analyzed in reverse to the order in which the operation requests are applied to the database, and the operation request determined to not relate to the particular operation request in the analysis process is skipped. This reduces the processing load concerning the analysis of the relationship.

In the above-described example, there are three operation requests for convenience of explanation. However, the number of operation requests and the types thereof are not limited to the example of FIG. 1. In the example of FIG. 1, the information processing apparatus 10, server apparatus 21, and terminal apparatus 30 are illustrated as separate bodies. However, the functions of the information processing apparatus 10 may be provided for the server apparatus 21 or terminal apparatus 30 as a modification.

In the above-described example, the expressions of “server” and “terminal” are used for convenience of explanation but do not limit the usages thereof. The functions of the information processing apparatus 10, server apparatus 21, and terminal apparatus 30 may be implemented by using various types of computers such as personal computers, server devices, smartphones, and tablet terminals, for example. Moreover, the network 40 is a LAN by way of example. However, in addition to a wired or wireless LAN, the network 40 may be configured as various types of communication lines such as an optical network or a dedicated line.

Hereinabove, the first embodiment is described.

### 2. Second Embodiment

Next, a description is given of a second embodiment. The second embodiment is related to a method of specifying an HTTP communication that relates to a particular HTTP communication (an HTTP communication as a reproduction target) among a series of HTTP communications (HTTP requests) requesting execution of SQL statements.

The relationship between HTTP communications is determined based on whether the result from executing an SQL statement corresponding to the reproduction target changes when an SQL statement which is executed before the SQL statement corresponding to the reproduction target is omitted. When the execution result changes, it is determined that the HTTP communication corresponding to the omitted SQL statement relates to the reproduction target.

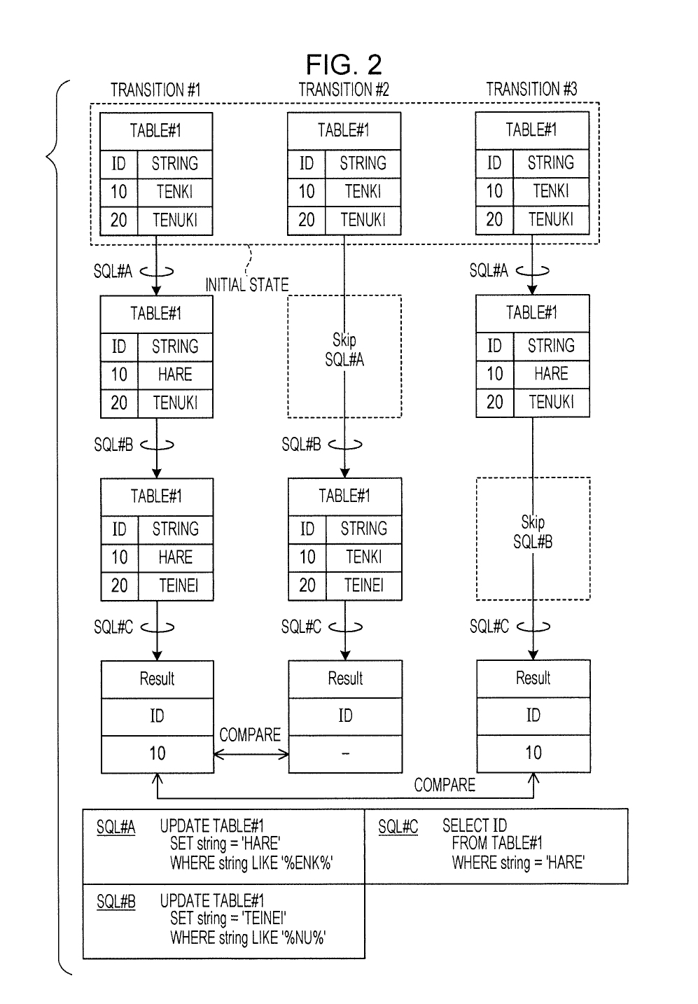

The relationship between HTTP communications is analyzed using a method of analyzing the relationship between SQL statements illustrated in FIG. 2, for example. FIG. 2 is a diagram illustrating an example of the method of analyzing the relationship between SQL statements. In the example of FIG. 2, an SQL statement relating to SQL #C is specified in a situation where SQL #A, #B, and #C are applied to TABLE #1 sequentially.

SQL #A and #B are examples (UPDATE statements) of update SQL statements to update values of “string” fields in TABLE #1. SQL #C is an example (an SELECT statement) of reference SQL statements to specify the value of a “string” field in TABLE #1 as the search condition and output the value of the “ID” field in the row that matches the search condition.

As indicated by transition #1 illustrated in FIG. 2, when SQL #A, #B, and #C are sequentially applied to TABLE #1, value “10” of the “ID” field is outputted as the result from executing SQL #C. On the other hand, when SQL #C is skipped as indicated by transition #2, there is no row that matches the search condition of SQL #C, and no significant value is outputted as the result from executing SQL #C.

Comparing transitions #1 and #2 indicates that executing SQL #C produces different results. This represents that skipped SQL#A relates to SQL #C. In a similar manner, comparing transition #1 and transition #3, that skips SQL #B, indicates that executing SQL #C produces the same result. This represents that skipped SQL #B does not relate to SQL #C.

In the case where execution of SQL #A, #B, and #C is requested through HTTP communication #A, #B, and #C, respectively, the HTTP communication that relates to HTTP communication #C as the reproduction target is HTTP communication #A. Moreover, when execution of SQL #A and #B is requested through HTTP communication #X while execution of SQL #C is requested through HTTP communication #Y, it is determined that HTTP communications #X and #Y are related.

In the following description, the process with which the information processing apparatus 100 reproduces operations for the database using SQL statements executed by the server apparatus 220 is referred to as a “test” in some cases. Moreover, the “test” also refers to a process to acquire the result from executing an SQL statement corresponding to the reproduction target when another SQL statement executed in the middle of a series of SQL statements is skipped or when an HTTP communication included in the middle of a series of HTTP communications is skipped.

By applying the aforementioned method to every SQL statement corresponding to the series of HTTP communications, the HTTP communication that relates to the reproduction target is specified. However, an increase in the number of SQL statements to be processed increases the processing load concerning specifying the HTTP communication that relates to the reproduction target and increases the time spent on the processing. The second embodiment therefore provides a method to efficiently analyze the relationship between HTTP communications.

[2-1 System]

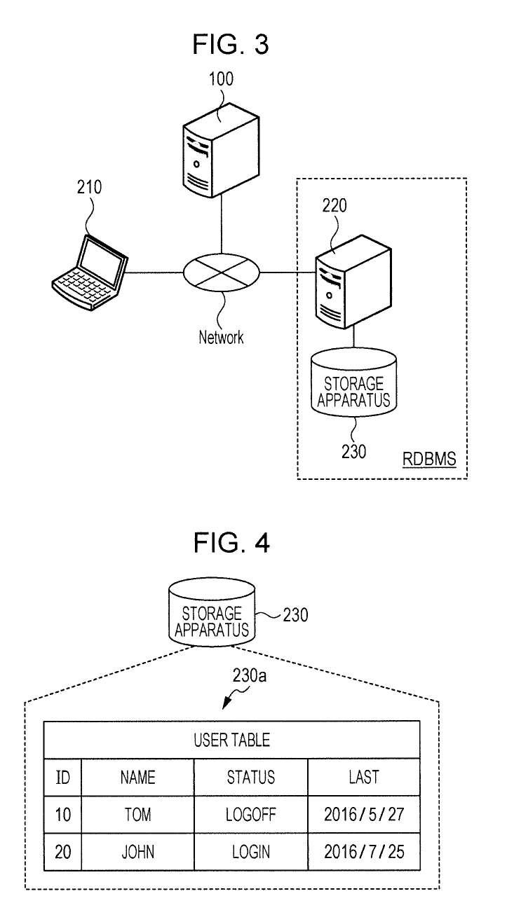

A description is given of a system according to the second embodiment with reference to FIG. 3. FIG. 3 is a diagram illustrating an example of the system according to the second embodiment. The system illustrated in FIG. 3 is just an example, and the number and types of elements included in the system may be changed. The following description is given using the system of FIG. 3 by way of example for convenience of explanation.

As illustrated in FIG. 3, the aforementioned system includes an information processing apparatus 100, a client apparatus 210, a server apparatus 220, and a storage apparatus 230. The information processing apparatus 100, client apparatus 210, and server apparatus 220 are coupled through a network such as a LAN or a wide area network (WAN), for example. The server apparatus 220 and storage apparatus 230 function as a database system such as an RDBMS, for example.

The storage apparatus 230 is a recording medium, such as an HDD or a solid state drive (SSD), or an RAID apparatus including plural recording media, for example. The storage apparatus 230 stores a database including a table illustrated in FIG. 4 (a USER table 230a), for example. FIG. 4 is a diagram illustrating an example of the database.

In the case of a RDBMS, the database stored in the storage apparatus 230 includes plural tables. The RDBMS manages the plural tables in association with each other. The USER table 230a illustrated in FIG. 4 is one of the tables included in the database stored in the storage apparatus 230.

The later-described technique of the second embodiment is also applicable to a database system different from RDBMS. The technique of the second embodiment is applicable to a database system that manages data with a method different from the method of managing data by relating tables to each other like RDBMSs, for example. The following description is given using the contents of the USER table 230a illustrated in FIG. 4 by way of example for convenience of explanation.

The client apparatus 210 is a computer that the user of a database stored in the storage apparatus 230 uses to operate the database. The client apparatus 210 requests the server apparatus 220 to execute SQL statements through HTTP communications according to the user's operations.

The server apparatus 220 receives an HTTP communication to request execution of an SQL statement and creates the SQL statement according to the contents of the received HTTP communication. The server apparatus 220 executes the created SQL statement to operate the database stored in the storage apparatus 230.

The server apparatus 220 executes an update SQL statement to update the contents of the USER table 230a, for example. The server apparatus 220 executes a reference SQL statement to extract data that matches the search condition from the USER table 230a and transmit the extracted data to the client apparatus 210 (response).

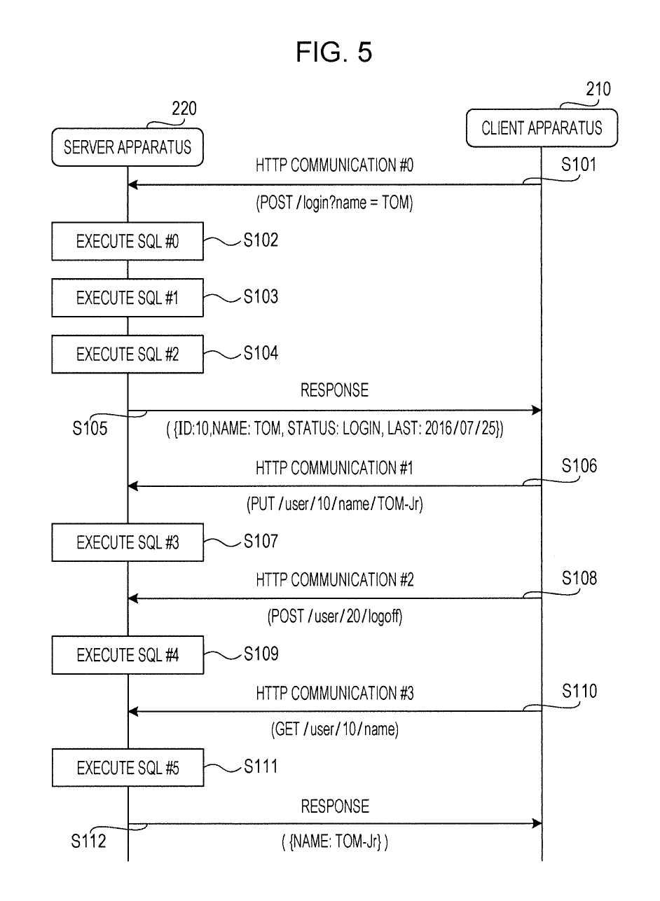

For example, HTTP communications that request execution of SQL statements and responses to the requests are performed according to the flow illustrated in FIG. 5. FIG. 5 is a sequence chart illustrating an operation example of the server apparatus and client apparatus concerning operations for the database.

In the following description, the k-th HTTP communication is sometimes represented as HTTP communication #k for convenience of explanation. In this case, k is an HTTP serial number (identification information to identify the HTTP communication) of the HTTP communication #k. Moreover, the SQL statement executed n-th is represented as SQL #n in some cases. In this case, n is an SQL serial number (identification information to identify the SQL statement) of the SQL #n.

In the example of FIG. 5, the client apparatus 210 requests the server apparatus 220 to execute SQLs #0, #1, . . . , #5 through HTTP communications #0, #1, #2, and #3. HTTP communication #0 corresponds to SQLs #0, #1, and #2. HTTP communications #1, #2, and #3 correspond to SQLs #3, #4, and #5, respectively.

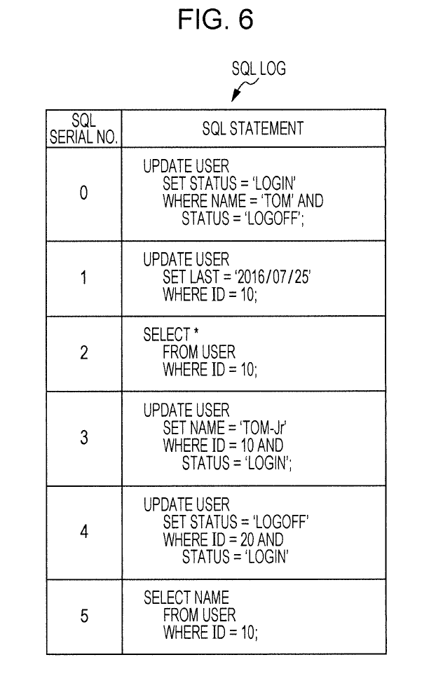

In the example of FIG. 5, SQLs #0, #1, . . . , #5 include the contents as illustrated in FIG. 6. FIG. 6 is a diagram illustrating an example of an SQL log. SQLs #0, #1, . . . , #5 are sequentially applied to the USER table 230a which includes the contents of the USER table 230a illustrated in FIG. 4 in the initial state (the state before SQL #0 is executed).

(S101) The client apparatus 210 requests the server apparatus 220 to execute an SQL statement through HTTP communication #0. In the example of FIG. 5, as HTTP communication #0, an HTTP request including a POST statement (given in brackets under the S101 arrow) is transmitted from the client apparatus 210 to the server apparatus 220.

(S102, S103, S104) The server apparatus 220 interprets the contents of the HTTP request received from the client apparatus 210 and creates SQLs #0, #1, and #2 corresponding to the POST statement included in the received HTTP request. The server apparatus 220 executes SQLs #0, #1, and #2 in ascending order of SQL serial numbers.

(S105) The server apparatus 220 transmits the results from executing SQLs #0, #1, and #2, as the response to the HTTP request received from the client apparatus 210, to the client apparatus 210. In this case, the output of SQL #2, which is a reference SQL statement, is transmitted from the server apparatus 220 to the client apparatus 210.

(S106) The client apparatus 210 requests the server apparatus 220 to execute an SQL statement through HTTP communication #1. In the example of FIG. 5, as HTTP communication #1, an HTTP request including a PUT statement (given in brackets under the S106 arrow) is transmitted from the client apparatus 210 to the server apparatus 220.

(S107) The server apparatus 220 interprets the contents of the HTTP request received from the client apparatus 210 and creates SQL #3 (an update SQL statement; see FIG. 6) corresponding to the PUT statement included in the received HTTP request. The server apparatus 220 executes SQL #3.

(S108) The client apparatus 210 requests the server apparatus 220 to execute an SQL statement through the HTTP communication #2. In the example of FIG. 5, as HTTP communication #2, an HTTP request including a POST statement (given in brackets under the S108 arrow) is transmitted from the client apparatus 210 to the server apparatus 220.

(S109) The server apparatus 220 interprets the contents of the HTTP request received from the client apparatus 210 and creates SQL #4 (an update SQL statement; see FIG. 6) corresponding to the POST statement included in the received HTTP request. The server apparatus 220 executes SQL #4.

(S110) The client apparatus 210 requests the server apparatus 220 to execute an SQL statement through the HTTP communication #3. In the example of FIG. 5, as HTTP communication #3, an HTTP request including a GET statement (given in brackets under the S110 arrow) is transmitted from the client apparatus 210 to the server apparatus 220.

(S111) The server apparatus 220 interprets the contents of the HTTP request received from the client apparatus 210 and creates SQL #5 (a reference SQL statement; see FIG. 6) corresponding to the GET statement included in the received HTTP request. The server apparatus 220 executes SQL #5.

(S112) The server apparatus 220 transmits the result from executing SQL #5 (the output of SQL #5, which is a reference SQL statement), as the response to the HTTP request received from the client apparatus 210, to the client apparatus 210. When the processing of S112 is completed, the series of procedures illustrated in FIG. 5 is finished.

GET, POST, and PUT described above are examples of HTTP methods. GET is the method to request provision of information specified by a uniform resource identifier (URI). POST is the method to transfer a set of data name and a value corresponding to the data name, to the destination.

PUT is the method to request replacement of information specified by the URI. In addition, HTTP methods include DELETE to request deletion of information specified by a URI. In a Web-based database system, the database is operated by using the HTTP methods as described above.

Hereinabove, the system is described.

[2-2 Hardware]

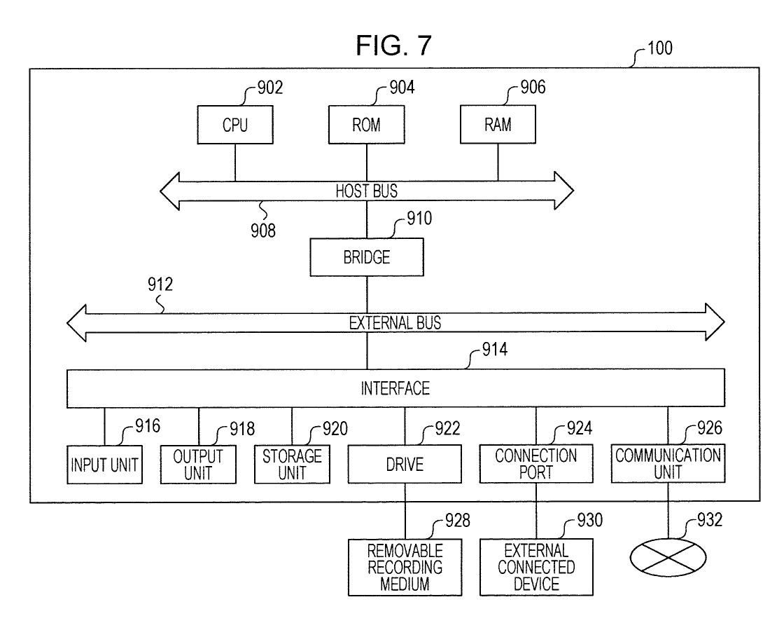

Next, a description is given of the hardware of the information processing apparatus 100 with reference to FIG. 7. FIG. 7 is a block diagram illustrating an example of hardware capable of implementing the functions of the information processing apparatus according to the second embodiment.

The functions of the information processing apparatus 100 are implemented by using hardware resources illustrated in FIG. 7, for example. In other words, the functions of the information processing apparatus 100 may be implemented by using a computer program to control the hardware illustrated in FIG. 7.

As illustrated in FIG. 7, the hardware mainly includes a CPU 902, a read only memory (ROM) 904, a RAM 906, a host bus 908, and a bridge 910. The hardware further includes an external bus 912, an interface 914, an input unit 916, an output unit 918, a storage unit 920, a drive 922, a connection port 924, and a communication unit 926.

The CPU 902 functions as an arithmetic processor or a controller, for example. The CPU 902 controls all or a part of the operation of each constituent element based on various programs recorded in the ROM 904, the RAM 906, the storage unit 920, or a removable recording medium 928. The ROM 904 is an example of a storage apparatus storing programs which are loaded by the CPU 902 and data used for calculation. The RAM 906 temporarily or permanently stores programs which are loaded by the CPU 902 or various types of parameters varying at executing the programs.

These elements are coupled to each other through the host bus 908 capable of performing high-speed data transmission, for example. On the other hand, the host bus 908 is coupled to the external bus 912 of a comparatively low data transmission rate through the bridge 910, for example. Examples of the input unit 916 include a mouse, a keyboard, a touch panel, a touch pad, a button, a switch, and a lever. The input unit 916 is also a remote controller capable of transmitting control signal by using infrared rays or other radio waves.

The output unit 918 is a display apparatus such as a cathode ray tube (CRT), a liquid crystal display (LCD), a plasma display panel (PDP), or an electro-luminescence display (ELD). The output unit 918 is an audio output apparatus or a printer in some cases.

The storage unit 920 is a device storing various types of data. The storage unit 920 is a magnetic storage device such as an HDD. The storage unit 920 may be a semiconductor storage device such as an SSD or a RAM disk, an optical storage device, a magneto-optical storage device, or the like.

The drive 922 is a device which reads information recorded in the removable recording medium 928 as a detachable recording medium or writes information in the removable recording medium 928. Examples of the removable recording medium 928 include a magnetic disk, an optical disk, a magneto-optical disk, and a semiconductor memory.

The connection port 924 is a port for connection with an external connected device 930. The connection port 924 is a Universal Serial Bus (USB) port, an IEEE1394 port, a Small Computer System Interface (SCSI), an RS-232C port, an optical audio terminal, or the like, for example. The external connected device 930 may be an external storage apparatus such as a RAID device, for example.

The communication unit 926 is a communication device for connection with the network 932. The communication unit 926 may be a communication circuit for wired or wireless LAN, a communication circuit for wireless USB (WUSB), a communication circuit or router for optical communication, a communication circuit or router for asymmetric digital subscriber lines (ADSL), a communication circuit for mobile phone networks, or the like. The network 932 coupled to the communication unit 926 is a network coupled in a wired or wireless manner. The network 932 includes the Internet, a LAN, or the like, for example.

Hereinabove, the hardware of the information processing apparatus 100 is described.

The functions of the client apparatus 210 and server apparatus 220 may be implemented using the hardware illustrated in FIG. 7 in a similar manner. The detailed description of the hardware of the client apparatus 210 and server apparatus 220 is omitted herein.

[2-3. Information Processing Apparatus]

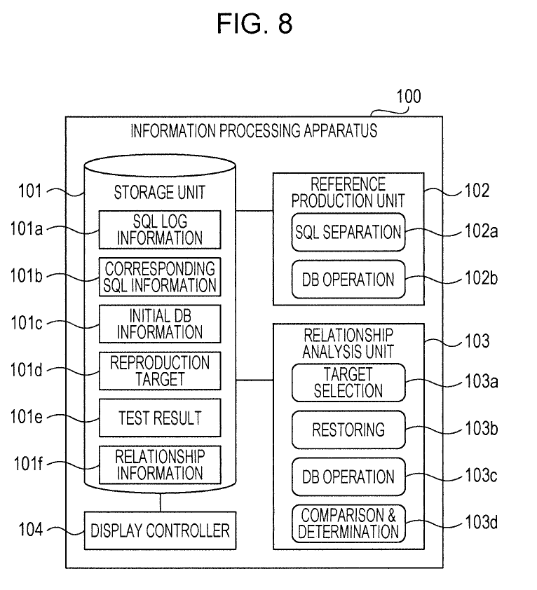

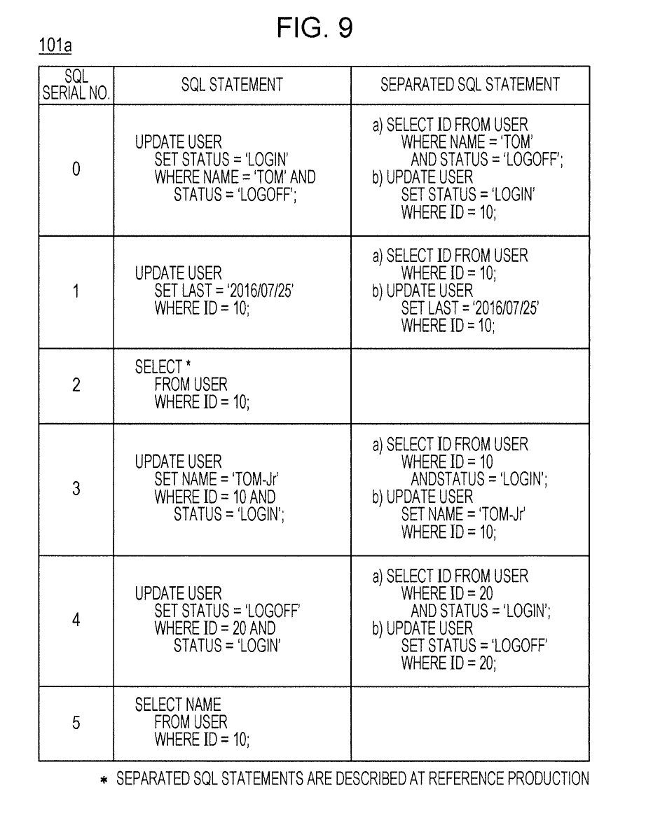

Next, a description is given of the functions of the information processing apparatus 100 with reference to FIG. 8. FIG. 8 is a block diagram illustrating examples of the functions included in the information processing apparatus according to the second embodiment.

As illustrated in FIG. 8, the information processing apparatus 100 includes a storage unit 101, a reference production unit 102, a relationship analysis unit 103, and a display controller 104. The function of the storage unit 101 is implemented by using the aforementioned RAM 906, storage unit 920, or the like. The functions of the reference production unit 102, relationship analysis unit 103, and display controller 104 are implemented by using the aforementioned CPU 902 or the like.

(Storage unit 101)

The storage unit 101 stores SQL log information 101a, corresponding SQL information 101b, initial DB information 101c, reproduction target information 101d, test result information 101e, and relationship information 101f.

The SQL log information 101a is information concerning the log of SQL statements that have been executed according to a series of HTTP communications (HTTP requests) by the server apparatus 220. The corresponding SQL information 101b is information concerning the correspondence relationship between HTTP communications and SQL statements. The initial DB information 101c is information concerning a database (the USER table 230a) before the SQL statements corresponding to the series of HTTP communications are executed.

The reproduction target information 101d is information concerning the last HTTP communication (the reproduction target) that is applied to the database (the USER table 230a) among the series of HTTP communications. The test result information 101e is information concerning the result (the output by executing SQL statements) of a test to specify the HTTP communication that relates to the reproduction target. The relationship information 101f is information concerning the HTTP communication that relates to the reproduction target.

(SQL Log Information 101a)

The aforementioned SQL log information 101a includes the contents as illustrated in FIG. 9, for example. FIG. 9 is a diagram illustrating an example of the SQL log information according to the second embodiment.

As illustrated in FIG. 9, the SQL log information 101a is information including SQL serial numbers, SQL statements, and separated SQL statements. The SQL serial numbers are identification information to identify SQL statements. The SQL serial numbers represent the order of execution of SQL statements. Each set of separated SQL statements produce the same output as the corresponding SQ statement.

An update SQL statement is separated into a reference SQL statement that specifies a row to be updated and an update SQL statement that updates the contents of the row specified by the reference SQL statement. For example, the SQL statement (SQL #0) corresponding to the SQL serial number 0 in FIG. 9 is an instruction to rewrite the value of STATUS in the row with NAME=“TOM” and STATUS=“LOGOFF”, to “LOGIN” in the USER table 230a.

Part of SQL #0 that specifies the row to be updated is the WHERE statement describing the search condition of: NAME=“TOM” and STATUS=“LOGOFF”. On the other hand, part of SQL #0 that specifies the way of updating is the SET statement describing an instruction to rewrite the value of STATUS to “LOGIN”. In the case of the USER table 230a, each row is specified using ID.

SQL #0 may be separated into a SELECT statement to output the value of ID of the row that matches the search condition described in the WHERE statement and an UPDATE statement to rewrite the value of STATUS corresponding to the value of ID outputted by the SELECT statement to “LOGIN”. In such a manner, an update SQL statement may be separated into plural SQL statements which produce the same output.

In the example of FIG. 9, SQLs #0, #1, #3, and #4, which are update SQL statements, may be each separated into plural SQL statements. The separated SQL statements are utilized in the process to produce the reference used to analyze the relationship between HTTP communications. Accordingly, each SQL statement is separated in the process to produce the reference, and the result thereof is described in a separated SQL statement field.

In the SQL log information 101a, the contents of the SQL serial number and SQL statement fields are acquired from the server apparatus 220 and stored in the storage unit 101 before execution of the process to analyze the relationship between HTTP communications.

(Corresponding SQL information 101b)

The aforementioned corresponding SQL information 101b includes the contents as illustrated in FIG. 10, for example. FIG. 10 is a diagram illustrating an example of the corresponding SQL information according to the second embodiment.

As illustrated in FIG. 10, the corresponding SQL information 101b includes HTTP serial numbers, SQL serial numbers, and HTTP metadata. The HTTP serial numbers are identification information used to identify respective HTTP communications. The HTTP serial numbers represent the order of issue of the HTTP communications (HTTP requests). The HTTP metadata include the contents of HTTP communications.

Each HTTP serial number is associated with at least one SQL serial number. In the example of FIG. 10, the HTTP communication with the HTTP serial number set to 0 (HTTP communication #0) is associated with three SQL serial numbers {0, 1, 2}. In other words, HTTP communication #0 is associated with SQLs #0, #1, and #2. In this example, HTTP communications #1, #2, and #3 are associated with SQLs #3, #4, and #5, respectively.

The contents of the corresponding SQL information 101b are acquired from the server apparatus 220 and stored in the storage unit 101 before execution of the process to analyze the relationship between HTTP communications.

(Reproduction Target Information 101d)

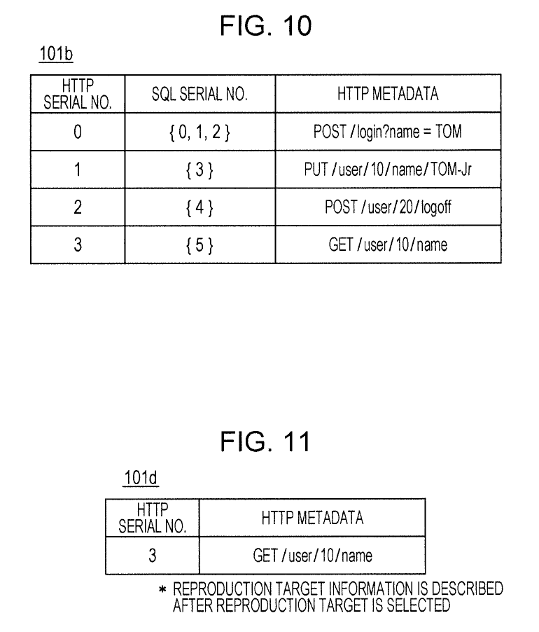

The above-described reproduction target information 101d includes the contents as illustrated in FIG. 11, for example. FIG. 11 is a diagram illustrating an example of the reproduction target information according to the second embodiment.

As illustrated in FIG. 11, the reproduction target information 101d includes an HTTP serial number and HTTP metadata. The HTTP serial number described in the reproduction target information 101d corresponds to the HTTP communication selected as the reproduction target by the user. The HTTP metadata described in the reproduction target information 101d includes the same contents as those of the HTTP metadata described in the corresponding SQL information 101b.

(Test Result Information 101e)

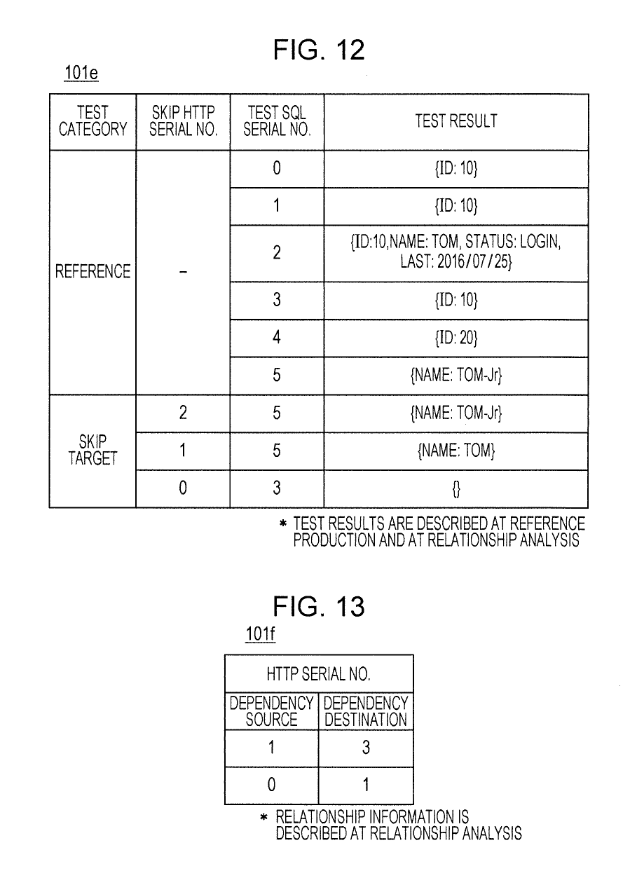

The above-described test result information 101e includes the contents as illustrated in FIG. 12, for example. FIG. 12 is a diagram illustrating an example of the test result information according to the second embodiment.

As illustrated in FIG. 12, the test result information 101e includes test categories, skipped HTTP serial numbers, test SQL serial numbers, and test results.

As described later, in order to specify the relationship between HTTP communications, tests are made which test a series of HTTP communications while skipping HTTP communications processed before the reproduction target and compare the results (test results) from executing the SQL statement corresponding the reproduction target in the cases with the HTTP communication of interest skipped and not skipped. The test results acquired with no HTTP communication skipped are used as the references at the above comparison and are described in association with a test category of “reference”.

The test SQL serial numbers are SQL serial numbers of SQL statements executed to acquire test results. In order to acquire test results as the reference, SQL statements (SQLs #0, #1, . . . , #5) corresponding to the series of HTTP communications are executed in ascending order of SQL serial numbers. Accordingly, 0, 1, . . . , 5 are described in the test SQL serial number fields corresponding to the test category “reference”, and the results from executing SQLs #0, #1, . . . #5 are described in the respective test result fields.

On the other hand, the test result acquired with an HTTP communication skipped is described in association with a test category of “skip”. In the “skip HTTP serial number” fields, HTTP serial numbers indicating skip HTTP communications (HTTP communications skipped at a test from the series of HTTP communications) are described. In the following description, an HTTP communication corresponding to a skip HTTP serial number is referred to as the skip HTTP communication in some cases. SQL statements corresponding test SQL serial numbers are referred to as test SQL statements in some cases.

(Relationship Information 101f)

The above-described relationship information 101f includes the contents as illustrated in FIG. 13, for example. FIG. 13 is a diagram illustrating an example of the relationship information according to the second embodiment.

As illustrated in FIG. 13, the relationship information 101f includes HTTP serial numbers of HTTP communications which are related. The process to specify an HTTP communication that relates to the reproduction target sometimes specifies an HTTP communication that indirectly relates to the reproduction target in addition to an HTTP communication that directly relates to the reproduction target. The relationship information 101f therefore sometimes includes HTTP serial numbers of two HTTP communications different from the reproduction target.

When the reproduction target is HTTP communication #3 and HTTP communications #1 and #3 are related, for example, in the relationship information 101f, the HTTP serial number of HTTP communication #1 is described in a “dependency source” field while the HTTP serial number of HTTP communication #3 is described in a “dependency destination” field. The dependency source refers to an HTTP communication which influences the result from executing the SQL statement of the dependency destination.

When the dependency destination is the HTTP communication selected as the reproduction target, the dependency source relates to the reproduction target directly. On the other hand, when HTTP communication #0 relates to HTTP communication #3 (the reproduction target) via HTTP communication #1, in the relationship information 101f, the HTTP serial number of HTTP communication #0 is described in a “dependency source” field while the HTTP serial number of HTTP communication #1 is described in a “dependency destination” field HTTP.

When HTTP communications #1 and #3 are related, HTTP communication #0 that influences the result from executing the SQL statement corresponding to HTTP communication #1 also influences the result from executing the SQL statement corresponding to HTTP communication #3. Accordingly, in the relationship information 101f, information of HTTP serial numbers representing the relationship between HTTP communications #0 and #1 is described. In such a manner, the relationship information 101f includes information of HTTP communications that relate to the reproduction target directly or indirectly.

(Reference Production Unit 102)

With reference to FIG. 8 again, the reference production unit 102 includes an SQL separation function 102a and a DB operation function 102b as illustrated in FIG. 8.

The reference production unit 102 produces a test result (a reference) with no HTTP communication skipped for comparison with a test result with a skip HTTP communication omitted.

The SQL separation function 102a is a function to, when the SQL statement as the test target is the update SQL statement, separate the SQL statement into a reference SQL statement to output ID specifying the row to be updated and an update SQL statement to update the raw with outputted ID. The reference production unit 102 creates separated SQL statements from the update SQL statement included in the SQL log information 101a with the SQL separation function 102a and describes the created separated SQL statements in the SQL log information 101a.

The DB operation function 102b is a function to apply the SQL statements included in the SQL log information 101a to the initial DB information 101c in order of SQL serial numbers (testing) and describe the results (test result) from executing reference SQL statements, in the test result information 101e. In the process of executing SQL statements by the DB operation function 102b, when the SQL log information 101a includes separated SQL statements, the reference production unit 102 executes the separated SQL statements.

(Relationship Analysis Unit)

The relationship analysis unit 103 includes a target selection function 103a, a restoring function 103b, a DB operation function 103c, and a comparison & determination function 103d as illustrated in FIG. 8.

The relationship analysis unit 103 selects HTTP communications preceding the reproduction target from a series of HTTP communications in reverse chronological order (in descending order of HTTP serial numbers) and executes a test with each of the selected HTTP communications (the skip HTTP communication) omitted. The relationship analysis unit 103 determines the relationship between the reproduction target and HTTP communication based on the comparison of the test result obtained with the skip HTTP communication omitted and the referential test result.

The target selection function 103a is a function to select the skip HTTP communication. The relationship analysis unit 103 uses the target selection function 103a to refer to the corresponding SQL information 101b and select HTTP communications having HTTP serial numbers smaller than that of the reproduction target one by one as the skip HTTP communication in descending order of HTTP serial numbers.

The restoring function 103b is a function to restore the contents of the database to the state just before the SQL statement corresponding to the skip HTTP communication is executed. The relationship analysis unit 103 uses the restoring function 103b to refer to the corresponding SQL information 101b and restore the contents of the database to the state prior to execution of the SQL statement having the smallest SQL serial number among the SQL serial numbers corresponding the skip HTTP serial number.

When the skip HTTP communication is HTTP communication #2, for example, the relationship analysis unit 103 acquires the contents of the database (the USER table 230a) in the state prior to execution of SQL #4 (after SQL #3 is executed) with the restoring function 103b.

The DB operation function 103c is a function to produce the test result by applying SQL statements corresponding to HTTP communications following the skip HTTP communication, to the contents of the database restored by the restoring function 103b. In the process of producing the test result with the DB operation function 103c, the relationship analysis unit 103 refers to the relationship information 101f and omits applying the SQL statements corresponding to HTTP communications not relating to the reproduction target.

The comparison & determination function 103d is a function to compare the test result produced by the DB operation function 103c with the referential test result corresponding to the same test result with reference to the test result information 101e and determine the relationship based on the comparison result.

When the two test results compared by the comparison & determination function 103d are different, the relationship analysis unit 103 determines that the HTTP communications corresponding to the two test results are related and describes the HTTP serial numbers of the related HTTP communications in the relationship information 101f.

(Display Controller 104)

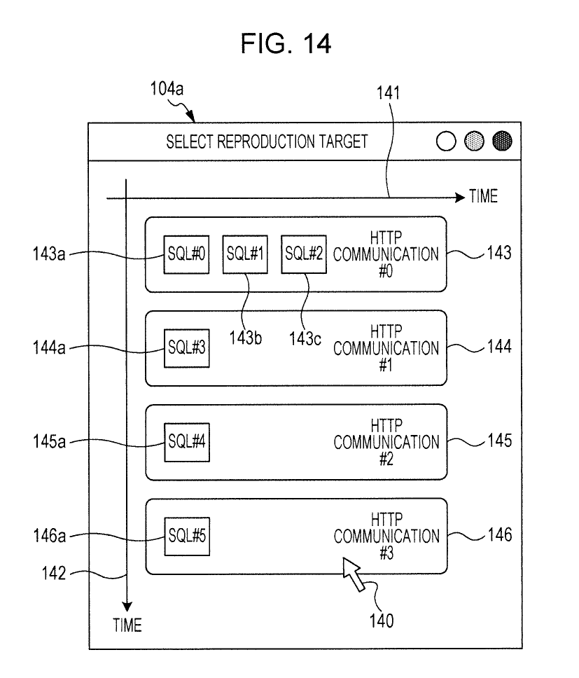

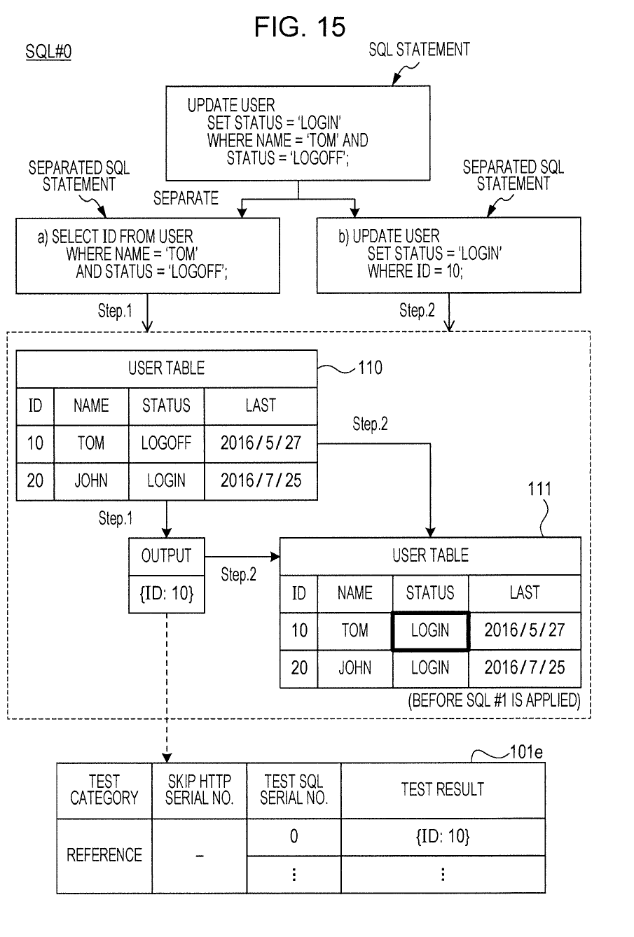

The display controller 104 displays information concerning a series of HTTP communications the relationship between which are allowed to be analyzed, on the display screen to prompt the user to select the reproduction target as illustrated in FIG. 14. FIG. 14 is a diagram illustrating an example of a reproduction target selection screen according to the second embodiment.

As illustrated in FIG. 14, the display controller 104 displays time axes 141 and 142 on a display screen 104a of the information processing apparatus 100, for example. The time axis 141 defines the order of execution of SQL statements. The time axis 142 defines the order of HTTP communications.

Boxes 143, 144, 145, and 146 are display information representing HTTP communications #0, #1, #2, and #3, respectively. Boxes 143a, 143b, 143c, 144a, 145a, and 146a are display information representing SQLs #0, #1, #2, #3, #4, and #5, respectively.

In the box 143 representing HTTP communication #0, for example, the boxes 143a, 143b, and 143c respectively representing SQLs #0, #1, and #2 are included. This indicates the correspondence relationship between HTTP communication #0 and SQLs #0, #1, and #2.

The display controller 104 displays the boxes 143, 144, 145, 146, 143a, 143b, 143c, 144a, 145a, and 146a on the display screen 104a, based on the corresponding SQL information 101b. The display controller 104 displays a cursor 140 for selecting the reproduction target. The user moves the cursor 140 on the display screen 104a to select an HTTP communication to be reproduced.

The HTTP serial number and metadata of the HTTP communication selected as the reproduction target by the user are described in the reproduction target information 101d by the display controller 104. After the analysis process by the relationship analysis unit 103 is completed, the display controller 104 displays the analysis result on the display screen 104a based on the relationship information 101f.

The display screen 104a may be a display screen of a display apparatus coupled to a computer other than the information processing apparatus 100. The display screen 104a may be a display screen of a computer coupled to the information processing apparatus 100 through a network, such as the client apparatus 210 or server apparatus 220. Such modifications are also within the technical scope of the embodiment.

(Reference Producing Method)

A description is given of a method (a reference producing method) of producing referential test results illustrated in FIG. 12, based on the USER table 230a of FIG. 4, the SQL log information 101a (SQL statements) of FIG. 9, the corresponding SQL information 101b of FIG. 10, and the reproduction target information 101d of FIG. 11. The processing of the reference producing method is executed along processes of FIGS. 15 to 17.

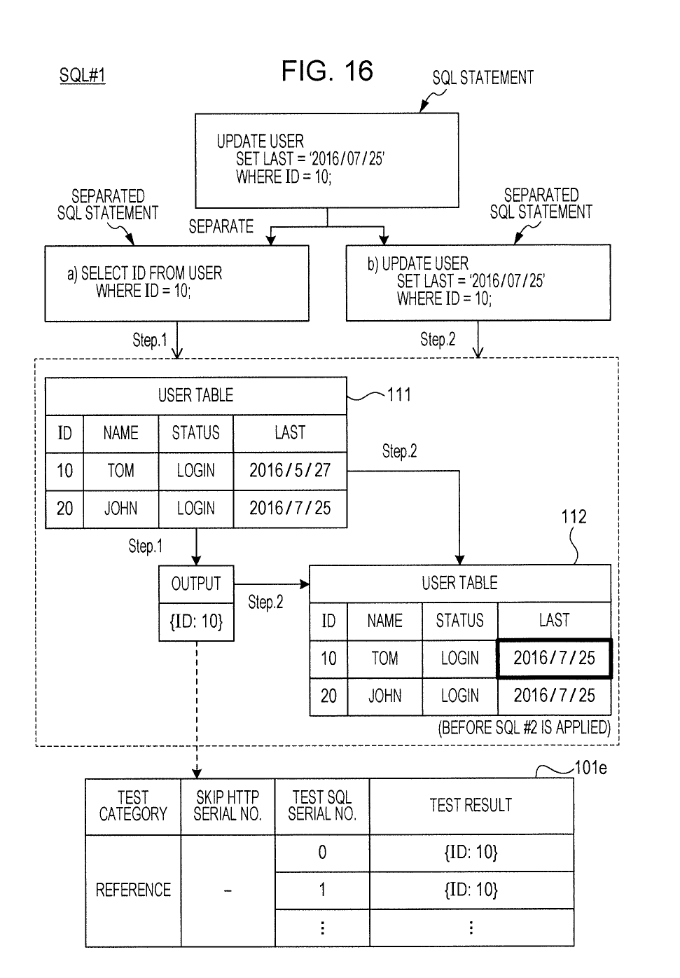

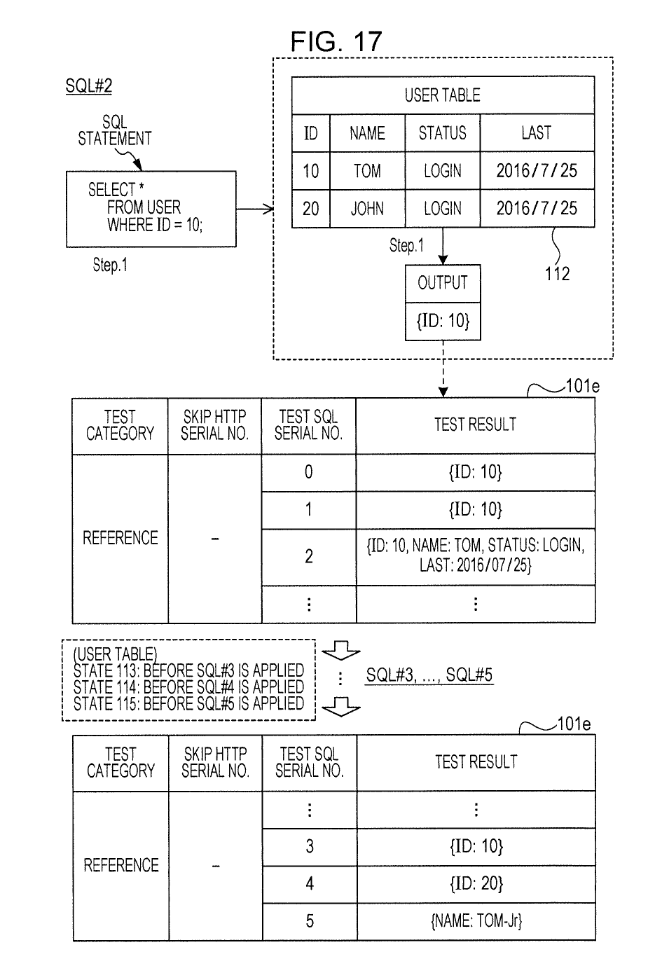

FIG. 15 is a first diagram illustrating an example of the reference producing method according to the second embodiment. FIG. 16 is a second diagram illustrating the example of the reference producing method according to the second embodiment. FIG. 17 is a third diagram illustrating the example of the reference producing method according to the second embodiment.

The reference production unit 102 specifies a table (the USER table 230a) to which SQL statements are to be applied, based on the SQL log information 101a. The reference production unit 102 acquires, as the initial DB information 101c, the USER table 230a before execution of the SQL statements included in the SQL log information 101a. The reference production unit 102 then executes the SQL statements (SQLs #0, #1, . . . , #5) in order of SQL serial numbers with reference to the SQL log information 101a.

As illustrated in FIG. 9, SQL #0 is an SQL statement (an update SQL statement) which sets the value of STATUS in the row with NAME=“TOM” and STATUS=“LOGOFF”, to “LOGIN” in the USER table 230a.

The reference production unit 102 separates the SQL statement of SQL #0 as illustrated in FIG. 15. In the case of SQL #0, the reference production unit 102 separates the SQL statement to create separate statements including: an SQL statement (a) to output the value of ID identifying the row with NAME=“TOM” and STATUS=“LOGOFF”, and an SQL statement (b) to set STATUS in the row of the outputted value of ID to “LOGIN”. The search condition (the WHERE statement) of the SQL statement (b) is set after the SQL statement (a) is executed. The created SQL statements (a, b) are described in a “separated SQL statement” field of the SQL log information 101a.

The reference production unit 102 applies the separated SQL statement (a) to the USER table 230a (Step 1). When the separated SQL statement (a) is applied to the USER table 230a of the initial DB information 101c (the USER table 230a in the initial state 110), the value “10” of ID is outputted. The reference production unit 102 describes the SQL serial number of SQL #0 as the test SQL serial number and the outputted value “10” of ID as the test result in the test result information 101e.

The reference production unit 102 applies the separated SQL statement (b) with the search condition set to ID=“10” outputted in Step 1, to the USER table 230a in the initial state 110 (Step 2). When the separated SQL statement (b) is applied to the USER table 230a, STATUS in the row with ID=“10” is updated to “LOGIN”, and the USER table 230a transforms into the state with SQL #0 applied (a state 111 before SQL #1 is applied). The reference production unit 102 may store the USER table 230a in the state 111 before SQL #1 is applied, in the storage unit 101.

Next, the reference production unit 102 executes SQL #1. As illustrated in FIG. 9, SQL #1 is an SQL statement (an update SQL statement) to set the value of LAST in the row with ID=“10” at “2016/07/25”, in the USER table 230a.

The reference production unit 102 separates the SQL statement of SQL #1 as illustrated in FIG. 16. In the case of SQL #1, the reference production unit 102 separates the SQL statement to create separate statements including: an SQL statement (a) to output ID identifying the row with ID=“10”; and an SQL statement (b) to set LAST in the row with the outputted value of ID at “2016/07/25”. The search condition (WHERE statement) of the SQL statement (b) is set after the SQL statement (a) is executed. The separated SQL statements (a, b) are described in a “separated SQL statement” field of the SQL log information 101a.

The reference production unit 102 applies the separated SQL statement (a) to the USER table 230a in the state 111 before SQL #1 is applied (Step 1). When the separated SQL statement (a) is applied to the USER table 230a in the state 111 before SQL #1 is applied, the value “10” of ID is outputted. The reference production unit 102 describes the SQL serial number of SQL #1 as the test SQL serial number and the outputted value “10” of ID as the test result in the test result information 101e.

The reference production unit 102 applies the separated SQL statement (b) to the USER table 230a in the state 111 before SQL #1 is applied, with the search condition set at ID=“10” outputted in Step 1 (Step 2). When the separated SQL statement (b) is applied to the USER table 230a, LAST in the row with ID=“10” is updated to “2016/07/25”, and the USER table 230a transforms into the state with SQL #1 applied (a state 112 before SQL #2 is applied). The reference production unit 102 may store the USER table 230a in the state 112 before SQL #2 is applied, in the storage unit 101.

Next, the reference production unit 102 executes SQL #2 as illustrated in FIG. 17. As illustrated in FIG. 9, SQL #2 is an SQL statement (a reference SQL statement) to output all the values in the raw with ID=“10” in the USER table 230a. Since the SQL statement to be applied is a reference SQL statement, SQL #2 is not separated, and no SQL statement is described in the “separated SQL statement” field corresponding to SQL #2 in the SQL log information 101a.

The reference production unit 102 applies SQL #2 to the USER table 230a in the state 112 before SQL #2 is applied (Step 1). Applying SQL #2 produces outputs of the values of ID, NAME, STATUS, and LAST in the raw with ID=“10”, in the USER table 230a in the state 112 before SQL #2 is applied. The reference production unit 102 describes the SQL serial number of SQL #2 as the test SQL serial number and the outputted values: ID “10”, NAME “TOM”, STATUS “LOGIN”, and LAST “2016/07/25” as the test result, in the test result information 101e.

In a similar manner, the reference production unit 102 applies SQLs #3, #4, and #5 to the USER table 230a and describes the test results and the like in the test result information 101e. The state of the USER table 230a after SQL #2 is applied is sometimes referred to as a state 113 before SQL #3 is applied. In a similar manner, the state of the USER table 230a after SQL #3 is applied is sometimes referred to as a state 114 before SQL #4 is applied, and the state of the USER table 230a after SQL #4 is applied is sometimes referred to as a state 115 before SQL #5 is applied.

Through the aforementioned processes, the reference production unit 102 produces the separated SQL statements in the SQL log information 101a and the referential test results in the test result information 101e.

(Relationship Analysis Method)

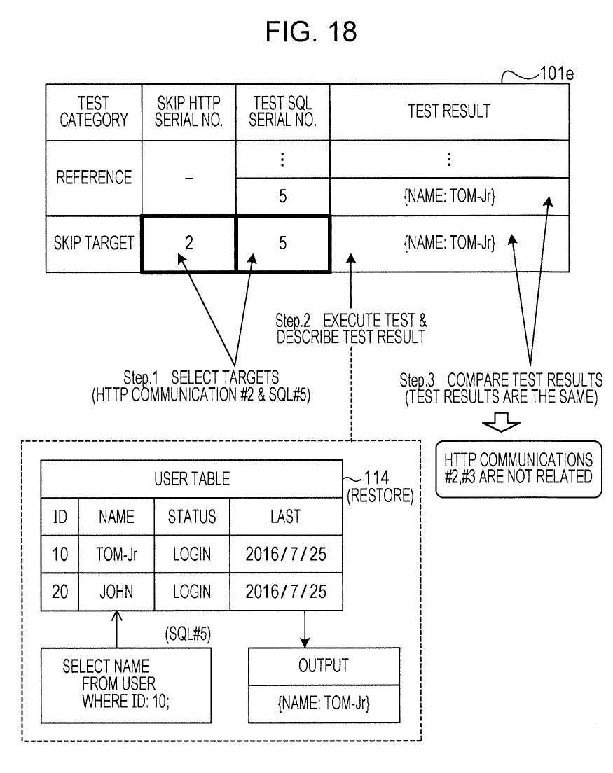

Next, a description is given of a method of analyzing the relationship between HTTP communications by using the references obtained by the aforementioned reference producing method (a relationship analysis method). The processing of the relationship analysis method is executed along the processes of FIGS. 18 to 20.

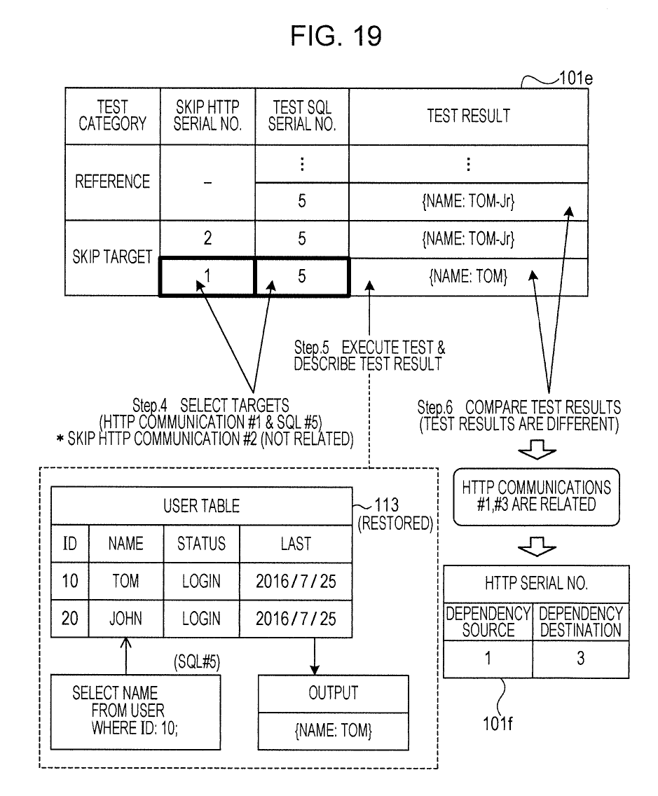

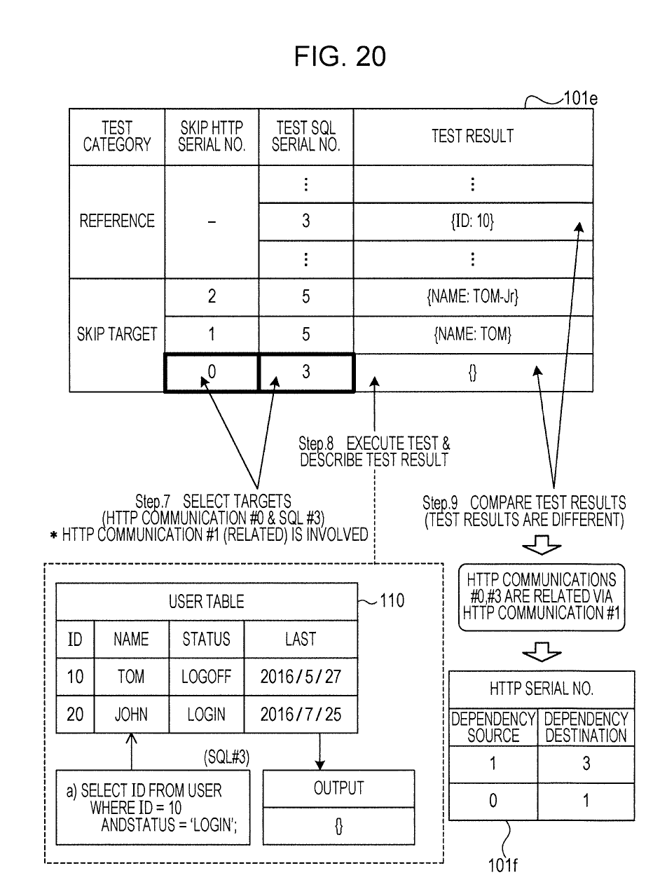

FIG. 18 is a first diagram illustrating an example of the relationship analysis method according to the second embodiment. FIG. 19 is a second diagram illustrating the example of the relationship analysis method according to the second embodiment. FIG. 20 is a third diagram illustrating the example of the relationship analysis method according to the second embodiment.

(Step 1) The relationship analysis unit 103 selects HTTP communication #2, which precedes the reproduction target (HTTP communication #3), as the skip HTTP communication, with reference to the corresponding SQL information 101b. As illustrated in FIG. 18, the relationship analysis unit 103 then describes the HTTP serial number of HTTP communication #2 in the test result information 101e as the skip HTTP serial number.

The relationship analysis unit 103 specifies HTTP communication #3, which follows the skip HTTP communication, with reference to the corresponding SQL information 101b. With reference to the SQL log information 101a, the relationship analysis unit 103 also specifies SQL #5 corresponding to the smallest SQL serial number (SQL serial number “5”; see FIG. 10) among SQL statements corresponding to the specified HTTP communication #3 as the test SQL statement. The relationship analysis unit 103 describes the SQL serial number of specified SQL #5 as the test SQL serial number in the test result information 101e as illustrated in FIG. 18.

The relationship analysis unit 103 acquires the USER table 230a in a state (the state 114 before SQL #4 is applied) before applying of the SQL statement (SQL #4) corresponding to the smallest SQL serial number among the SQL statements corresponding to the skip HTTP communication (HTTP communication #2). For example, the relationship analysis unit 103 acquires the USER table 230a in the state 114 before SQL #4 is applied, from the server apparatus 220.

When the USER table 230a in the state 114 before SQL #4 is applied is in the storage unit 101, the relationship analysis unit 103 may use the USER table 230a stored in the storage unit 101. The relationship analysis unit 103 may generate the USER table 230a in the state 114 before SQL #4 is applied, from the initial DB information 101c.

(Step 2) The relationship analysis unit 103 applies the test SQL statement (SQL #5) to the USER table 230a in the state 114 before SQL #4 is applied. The relationship analysis unit 103 describes the value outputted by applying the test SQL statement (the value “TOM-Jr” of NAME in this example), as the test result in the test result information 101e.

(Step 3) The relationship analysis unit 103 compares test results of “reference” with test results of “skip” which have identical test SQL serial numbers, with reference to the test result information 101e. When test results of “skip” and “reference” for the same test SQL serial number are identical, the relationship analysis unit 103 determines that the reproduction target (HTTP communication #3) does not relate to the skip HTTP communication (HTTP communication #2). In the example of FIG. 18, the test results (the values of NAME) are both “TOM-Jr”, and the relationship analysis unit 103 determines that HTTP communications #2 and #3 are not related.

(Step 4) The relationship analysis unit 103 selects HTTP communication #1, which precedes the previously-selected skip HTTP communication (HTTP communication #2), as the current skip HTTP communication with reference to the corresponding SQL information 101b. The relationship analysis unit 103 describes the HTTP serial number of HTTP communication #1 in the test result information 101e as the skip HTTP serial number as illustrated in FIG. 19.

With reference to the corresponding SQL information 101b and relationship information 101f, the relationship analysis unit 103 specifies the reproduction target and the HTTP communication (HTTP communication #3) relating to the reproduction target among the HTTP communications that follow the skip HTTP communication. In the example of FIG. 19, since HTTP communications #2 and #3 are not related, HTTP communication #2 is omitted from the targets for the specification. In the process of acquiring a test result with the skip HTTP serial number set to 1, therefore, execution of the SQL statement corresponding to HTTP communication #2 is omitted.

The relationship analysis unit 103 specifies SQL #5, which corresponds to the smallest SQL serial number (SQL serial number “5”; see FIG. 10) among the SQL statements corresponding to specified HTTP communication #3, as the test SQL statement, with reference to the SQL log information 101a. As illustrated in FIG. 19, the relationship analysis unit 103 describes the SQL serial number of specified SQL #5 as the test SQL serial number in the test result information 101e.

The relationship analysis unit 103 acquires the USER table 230a in a state (the state 113 before SQL #3 is applied) before applying of the SQL statement (SQL #3) corresponding to the smallest SQL serial number among the SQL statements corresponding to the skip HTTP communication (HTTP communication #1). The relationship analysis unit 103 acquires the USER table 230a in the state 113 before SQL #3 is applied, from the server apparatus 220, for example.

When the USER table 230a in the state 113 before SQL #3 is applied is in the storage unit 101, the relationship analysis unit 103 may use the USER table 230a in the storage unit 101. The relationship analysis unit 103 may generate the USER table 230a in the state 113 before SQL #3 is applied, from the initial DB information 101c.

(Step 5) The relationship analysis unit 103 applies the test SQL statement (SQL #5) to the USER table 230a in the state 113 before SQL #3 is applied. The relationship analysis unit 103 describes the value outputted by applying the test SQL statement (the value “TOM” of NAME in this example) as the test result in the test result information 101e.

(Step 6) The relationship analysis unit 103 compares the test result of “reference” with the test result of “skip” for the same test SQL serial number with reference to the test result information 101e. In the example of FIG. 19, the test result (the value of NAME) of “reference” is “TOM-Jr” while the test result of “skip” is “TOM”. The test results are thus different. The relationship analysis unit 103 therefore determines that HTTP communications #1 and #3 are related.

The relationship analysis unit 103 describes the HTTP serial number of the HTTP communication (HTTP communication #1) in the “dependency source” field of the relationship information 101f and the HTTP serial number of the reproduction target (HTTP communication #3) in the “dependency destination” field.

(Step 7) The relationship analysis unit 103 selects HTTP communication #0, which precedes the previously-selected skip HTTP communication (HTTP communication #1), as the current skip HTTP communication with reference to the corresponding SQL information 101b. The relationship analysis unit 103 describes the HTTP serial number of HTTP communication #0 in the test result information 101e as the skip HTTP serial number as illustrated in FIG. 20.

The relationship analysis unit 103 specifies the reproduction target and the HTTP communication (HTTP communication #1) relating to the reproduction target with reference to the corresponding SQL information 101b and relationship information 101f. In the example of FIG. 20, since HTTP communications #2 and #3 are not related, HTTP communication #2 is omitted from the targets for the specification. In the process of acquiring a test result with the skip HTTP serial number set to 0, therefore, execution of the SQL statement corresponding to HTTP communication #2 is omitted.

The relationship analysis unit 103 specifies SQL #3, which corresponds to the smallest SQL serial number (SQL serial number “3”; see FIG. 10) among the SQL statements corresponding to specified HTTP communications #1 and #3, as the test SQL statement with reference to SQL log information 101a. As illustrated in FIG. 20, the relationship analysis unit 103 describes the SQL serial number of SQL #3 specified as the test SQL serial number in the test result information 101e.

The relationship analysis unit 103 acquires the USER table 230a in a state (the initial state 110) before applying of the SQL statement (SQL #0) corresponding to the smallest SQL serial number among the SQL statements corresponding to the skip HTTP communication (HTTP communication #0). The relationship analysis unit 103 acquires the USER table 230a in the initial state 110 from the initial DB information 101c, for example.

(Step 8) The relationship analysis unit 103 applies the test SQL (SQL #3) to the USER table 230a in the initial state 110. The relationship analysis unit 103 describes the value outputted by applying the test SQL (not outputted in this example; blank) in the test result information 101e as the test result.

(Step 9) The relationship analysis unit 103 compares the test result of “reference” with the test result of “skip” for the same identical test SQL serial number with reference to the test result information 101e. In the example of FIG. 20, the test result (the value of ID) of “reference” is “10” while the test result of “skip” is “blank”. The test results are thus different. The relationship analysis unit 103 therefore determines that HTTP communication #0 as the skip HTTP communication relates to HTTP communication #1 corresponding to the test SQL (SQL #3).

In this case, the relationship analysis unit 103 therefore determines that HTTP communication #0 as the skip HTTP communication (indirectly) relates to HTTP communication #3 as the reproduction target via HTTP communication #1. The relationship analysis unit 103 describes the HTTP serial number of the skip HTTP communication (HTTP communication #1) in the “dependency source” field of the relationship information 101f and HTTP serial number of HTTP communication #1 in the “dependency destination” field.

With the aforementioned processes, the relationship between HTTP communications relating to the reproduction target is described in the relationship information 101f. Herein, the process of analyzing the direct relationship between HTTP communications #0 and #3 is omitted because detecting the relationship between HTTP communications #0 and #1 has revealed that the presence of HTTP communication #0 influences the result from executing the SQL statement corresponding to HTTP communication #3.

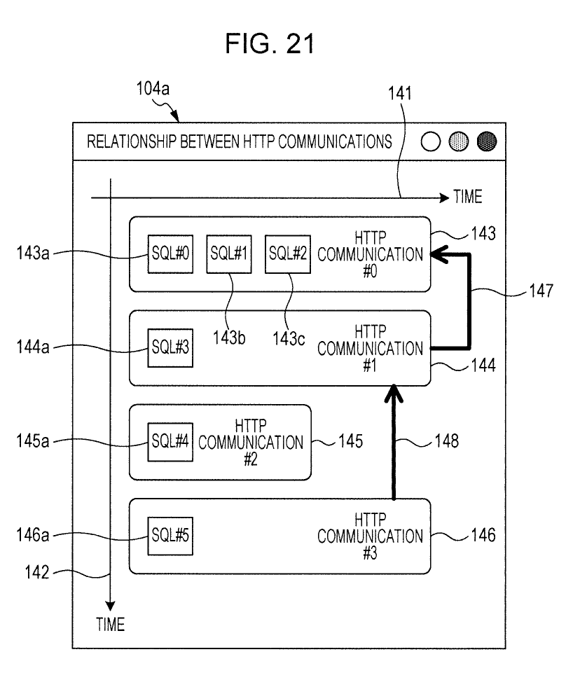

The aforementioned analysis result is displayed on the display screen 104a in the form illustrated in FIG. 21 by the display controller 104, for example. FIG. 21 is a diagram illustrating an example of the analysis result display screen according to the second embodiment. Arrows 147 and 148 are display information illustrating the relationship between HTTP communications.

The arrow 147 indicates that HTTP communications #0 and #1 are related. The arrow 147 indicates the direction from HTTP communication #1 as the dependency destination to HTTP communication #0 as the dependency source. The direction represents the direction of dependency. On the other hand, the arrow 148 indicates that HTTP communications #1 and #3 are related. The arrow 148 indicates the direction from HTTP communication #3 as the dependency destination to HTTP communication #1 as the dependency source. The direction represents the direction of dependency.

As illustrated in FIG. 21, the display controller 104 displays the arrows 147 and 148 linking HTTP communications directly relating to each other on the display screen 104a. Employment of such display clarifies the path from each HTTP communication relating to the reproduction target to the reproduction target. For example, when something is wrong with an output from the SQL statement corresponding to the reproduction target, investigation is sequentially performed along the linking path displayed on the display screen 104a. This is expected to determine the cause more quickly.

Hereinabove, the processes from the generation of the references to the analysis of relationship are described.

(Separation of Update SQL Statement)

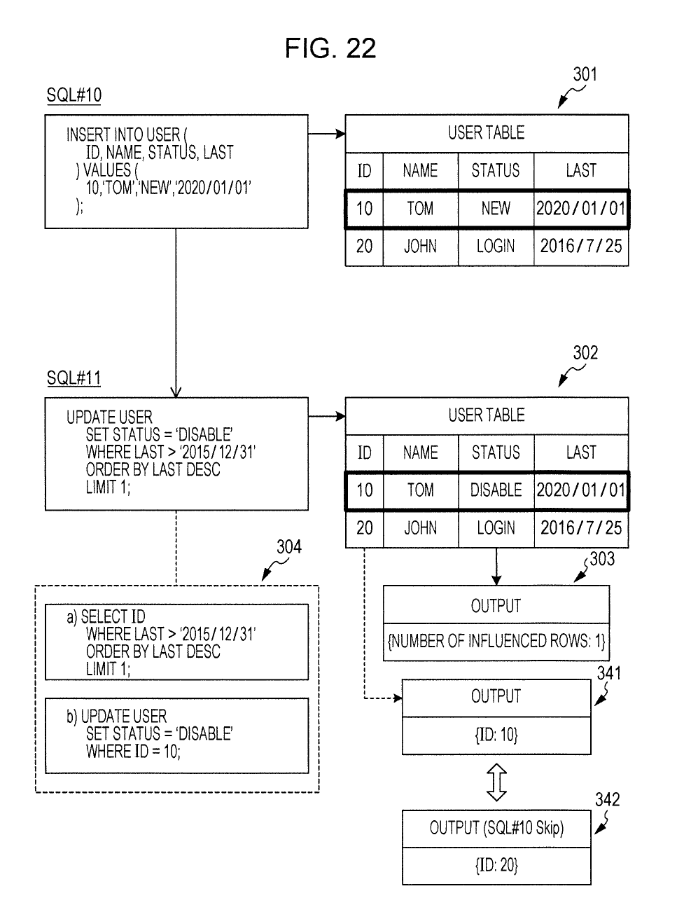

With reference to FIG. 22, the separation of update SQL statements is further described. FIG. 22 is a diagram illustrating an influence of separation of update SQL statements on the output.

As described above, the aforementioned reference producing method and relationship analysis method use separated SQL statements. The reason for the aforementioned methods to use separated SQL statements is to avoid a risk of incorrect determination caused by determining the relationship based on the result from comparing identification information identifying rows to be updated.

With a specification that the outputted test result is the number (the number of influenced rows) of rows of the USER table 230a influenced by execution of an update SQL statement, for example, there is a risk of incorrect determination.

In the example of FIG. 22, SQL #10 is applied to form a USER table 301, and SQL #11 is applied to the USER table 301 to form a USER table 302. The USER table 301 is formed by applying an INSERT statement (SQL #10) to insert the row with ID=10.

Next, when the UPDATE statement (SQL #11) is applied to the USER table 301, the row with ID=10 is updated, and an output 303 that the number of influenced rows is 1 is obtained. If SQL #10 is skipped, SQL #11 updates data in the row with ID=20. Accordingly, applying SQL #11, which is not separated, produces the same output 303 both when SQL #10 is skipped and when SQL #10 is not skipped. When “the number of influenced rows” is used to determine the relationship, it is not correctly determined that SQL #10 and #11 are not related (the updated contents are different between when SQL #10 is skipped and when SQL #10 is not skipped).

On the other hand, when a set 304 of SQL statements obtained by separating SQL #11 is used, the contents outputted when SQL #10 is not skipped is an output 341 indicating that ID is 10. The content outputted when SQL #10 is skipped is an output 342 indicating that ID is 20. Since the contents of the outputs 341 and 342 are different, it is correctly determined that SQLs #10 and #11 are related (the updated contents are different when SQL #10 is skipped and not skipped). In such a manner, separating an update SQL statement avoids a risk of incorrect determination.

Hereinabove, the functions of the information processing apparatus 100 are described.

[2-4. Process Flow]

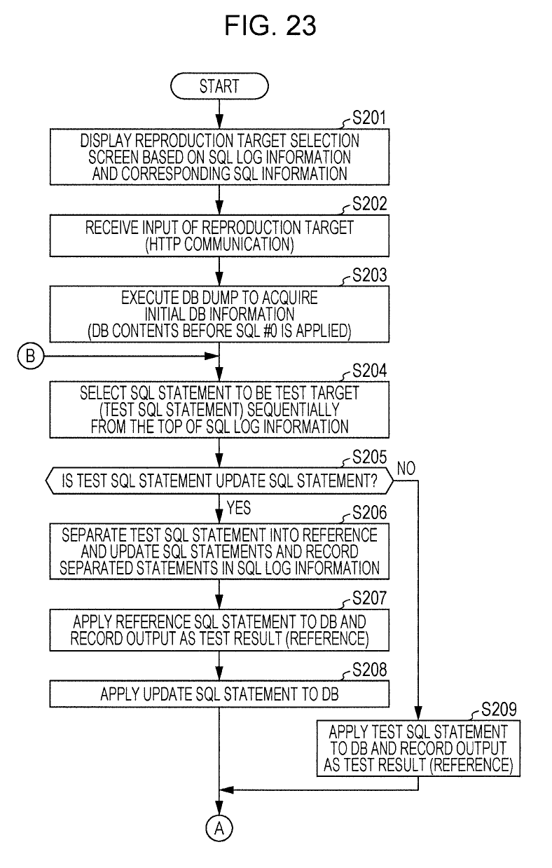

Next, with reference to FIGS. 23 to 25, a description is given of a flow of processing executed by the information processing apparatus 100. In the drawings, USER table 230a is referred to as DB.

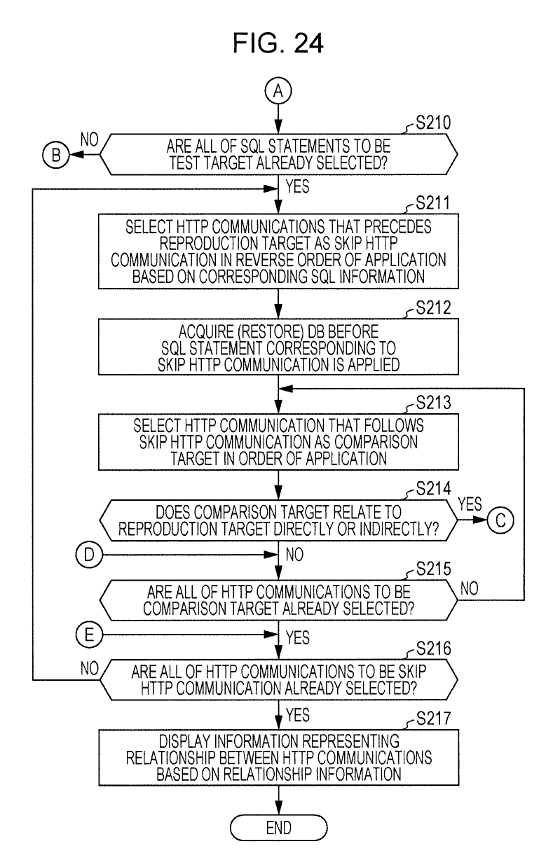

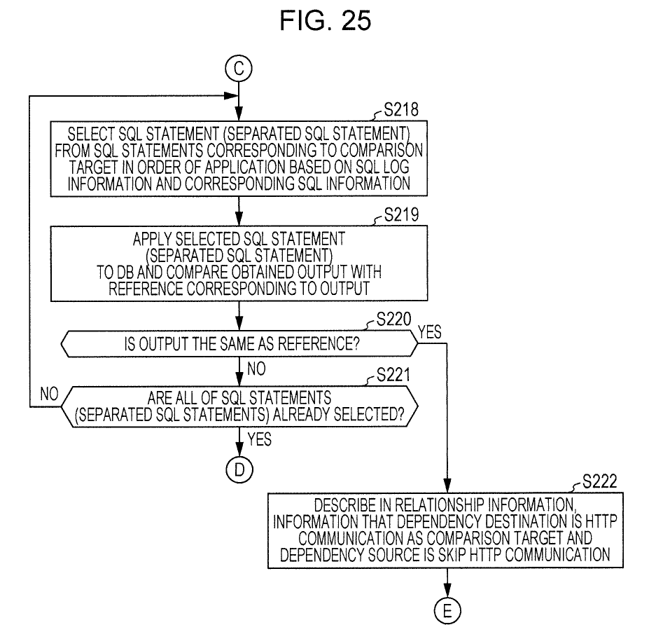

FIG. 23 is a first flowchart illustrating the flow of processing executed by the information processing apparatus according to the second embodiment. FIG. 24 is a second flowchart illustrating the flow of processing executed by the information processing apparatus according to the second embodiment. FIG. 25 is a third flowchart illustrating the flow of processing executed by the information processing apparatus according to the second embodiment.

(S201) The display controller 104 displays the reproduction target selection screen, based on the SQL log information 101a and corresponding SQL information 101b stored in the storage unit 101 (see FIG. 14).

(S202) The display controller 104 receives an input of an HTTP communication as the reproduction target. For example, the display controller 104 detects the superimposition relationship between the position of the cursor 140 operated by the user and the boxes 143, 144, 145, and 146 and specifies as the reproduction target, an HTTP communication corresponding to the box on which the cursor 140 is superimposed when the operation to select the reproduction target is performed. The display controller 104 describes the information about the specified HTTP communication in the reproduction target information 101d.

(S203) The reference production unit 102 executes DB dump to acquire the initial DB information 101c from the server apparatus 220 and stores the acquired initial DB information 101c in the storage unit 101.

When HTTP communication #3 is selected as the reproduction target and HTTP communications #0, #1, and #2 precede HTTP communication #3, the reference production unit 102 acquires the USER table 230a before execution of the SQL statement corresponding to HTTP communication #0. In this case, the reference production unit 102 acquires the USER table 230a in the state (the initial state 110) before SQL #0 is applied, as the initial DB information 101c.

(S204) As the test SQL statement, the reference production unit 102 selects unselected SQL statements from the SQL statements included in the SQL log information 101a one by one starting with the top (in ascending order of SQL serial numbers). The reference production unit 102 describes the SQL serial number of the selected test SQL statement in an “SQL serial number” field of the test result information 101e.

(S205) The reference production unit 102 determines whether the selected test SQL statement is an update SQL statement. When the test SQL statement is an update SQL statement, the process goes to S206. On the other hand, when the test SQL statement is not an update SQL statement (the test SQL statement is a reference SQL statement), the process goes to S209.

(S206) The reference production unit 102 separates the test SQL statement into a reference SQL statement and an update SQL statement. In this process, the reference production unit 102 creates a reference SQL statement to output identification information (ID) specifying a row to be updated by the test SQL statement, and an update SQL statement to apply an update operation by the test SQL statement with the search condition set at the output by the reference SQL statement. The reference production unit 102 records the reference and update SQL statements created by separating the test SQL statement in a “separated SQL statement” field of the SQL log information 101a.

(S207, S208) The reference production unit 102 applies the reference SQL statement recorded in the “separated SQL statement” field of the SQL log information 101a, to the USER table 230a. The reference production unit 102 records the contents outputted by applying the reference SQL statement, as the test result (reference) in the test result information 101e. The reference production unit 102 applies the update SQL statement recorded in the “separated SQL statement” field of the SQL log information 101a, to the USER table 230a, based on the output of the reference SQL statement. When the processing of S208 is completed, the process goes to S210.

(S209) The reference production unit 102 applies the test SQL to the USER table 230a and records the content outputted through the application as the test result (reference) in the test result information 101e. When the processing of S209 is completed, the process goes to S210.

(S210) With reference to the SQL log information 101a, the reference production unit 102 determines whether all of the SQL statements to be the test target (test SQL statements) are already selected. When all of the SQL statements to be the test target are already selected, the process goes to S211. When all of the SQL statements to be the test target are not selected yet, the process goes to S204.

The process from S201 to S210 corresponds to the above-described reference producing method. The process after S211 corresponds to the above-described relationship analysis method.

(S211) The relationship analysis unit 103 selects as the skip HTTP communication, HTTP communications that precede the reproduction target (in ascending order of HTTP serial numbers) one by one based on the corresponding SQL information 101b. In this process, the relationship analysis unit 103 selects unselected HTTP communications in reverse order of application (in descending order of HTTP serial numbers).

(S212) The relationship analysis unit 103 specifies the SQL statement having the smallest SQL serial number among the SQL statements corresponding to the skip HTTP communication with reference to the corresponding SQL information 101b. The relationship analysis unit 103 acquires the USER table 230a in the state before the specified SQL statement is applied (restoring). The relationship analysis unit 103 forms the restored USER table 230a or acquires the USER table 230a from the server apparatus 220.

(S213) With reference to the corresponding SQL information 101b, the relationship analysis unit 103 selects as a comparison target, unselected HTTP communications from the HTTP communications that follow the skip HTTP communication one by one in order of application (in ascending order of HTTP serial numbers).

(S214) The relationship analysis unit 103 determines whether or not the comparison target relates to the reproduction target directly or indirectly with reference to the relationship information 101f. When the comparison target relates to the reproduction target, the process goes to S218. When the comparison target does not relate to the reproduction target, the process goes to S215.

(S215) The relationship analysis unit 103 determines whether all of the HTTP communications to be a comparison target are already selected with reference to the corresponding SQL information 101b. When all of the HTTP communications to be the comparison target are already selected, the process goes to S216. When all of the HTTP communications to be the comparison target are not yet selected, the process goes to S213.

(S216) The relationship analysis unit 103 determines whether all of the HTTP communications to be the skip HTTP communication are already selected with reference to the corresponding SQL information 101b. When all of the HTTP communications to be the skip HTTP communication are already selected, the process goes to S217. When all of the HTTP communications to be the skip HTTP communication are not selected yet, the process goes to S211.

(S217) The display controller 104 displays information indicating the relationship between HTTP communications, based on the relationship information 101f (see FIG. 21). When the processing of S217 is completed, the series of procedures illustrated in FIGS. 23 to 25 is terminated.

(S218) The relationship analysis unit 103 selects an SQL statement in order of application (in ascending order of SQL serial numbers) from the SQL statements corresponding to the comparison target one by one based on the SQL log information 101a and corresponding SQL information 101b. In this process, when the SQL log information 101a includes separated SQL statements, the relationship analysis unit 103 selects one of the separated SQL statements.

(S219) The relationship analysis unit 103 applies the selected SQL statement (separated SQL statement) to the USER table 230a. The relationship analysis unit 103 compares the content (test results) outputted by applying the selected SQL statement (separated SQL statement) with the reference test result corresponding to the outputted contents with reference to the test result information 101e. In this process, the relationship analysis unit 103 compares the test results for the same test SQL serial number.

(S220) The relationship analysis unit 103 determines whether the test result outputted by applying the selected SQL statement (separated SQL statement) in S219 is the same as the referential test result. When the two test results are the same, the process goes to S222. When the two test results are different, the process goes to S221.

(S221) The relationship analysis unit 103 determines whether all of the SQL statements (separated SQL statements) corresponding to the comparison target are selected already. When all of the SQL statements (separated SQL statements) corresponding to the comparison target are selected already, the process goes to S215. When all of the SQL statements (separated SQL statements) corresponding to the comparison target are not selected yet, the process goes to S218.

(S222) The relationship analysis unit 103 describes information (HTTP serial numbers) indicating that the dependency destination is HTTP communication as the comparison target while the dependency source is the skip HTTP communication, in the relationship information 101f. When the processing of S222 is completed, the process goes to S216.

Hereinabove, the flow of processing executed by the information processing apparatus 100 is described.

By executing the processes along the aforementioned flow, some of the processes concerning HTTP communications not relating to the reproduction target are omitted. When a certain relationship is detected between an HTTP communication and the reproduction target by using some of the SQL statements corresponding to the HTTP communication, part or all of the processing concerning the remaining SQL statements corresponding to the HTTP communication are omitted. The processing load is therefore reduced.

Moreover, update SQL statements are separated to be applied to the USER table 230a, and the relationship between HTTP communications is determined according to the contents outputted by applying the separated SQL statements. This reduces a risk of incorrect determination. Moreover, displaying the direct relationship between HTTP communications allows the relational path to the reproduction target to be obvious at a glance, improving the convenience of the user utilizing the display.

Hereinabove, the second embodiment is described.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus comprising:
a memory configured to store a plurality of operation requests to be applied to a database sequentially and a first output result outputted when the plurality of operation requests are applied to the database; and
a processor coupled to the memory and configured to:
select a first operation request from among the plurality of operation requests,
acquire contents of the database before the first operation request is applied,
produce a second output result which is outputted when a series of operation requests to be applied after the first operation request of the plurality of operation requests are applied to the acquired contents of the database, and
determine that when the first output result matches with the second output result, the first operation request does not relate to a second operation request which is applied last among the plurality of operation requests, wherein
an operation request which does not relate to the second operation request in the series of operation requests is skipped when producing the second output result.

2. The apparatus of claim 1, wherein
among the plurality of operation requests, the processor selects as the first operation request, each operation request sequentially in reverse to order in which the operation requests are to be applied to the database.

3. The apparatus of claim 2, wherein
when the processor determines that the first operation request relates to a third operation request included in the series of operation requests during processing of producing the second output result for the first operation request, the processor further determines that the first operation request relates to the second operation request, and omits remaining part of the processing of producing the second output result for the first operation request.

4. The apparatus of claim 1, wherein
each of the plurality of operation requests corresponds to a set of statements which request at least one operation for the database, and
the set of statements includes at least one of a first statement concerning an operation which involves updating the database and a second statement concerning an operation which does not involve updating the database.

5. The apparatus of claim 4, wherein
the processor is further configured to:
at applying an operation request including the first statement among the plurality of operation requests to the database, extract a condition to narrow targets for operation and content of the operation from the first statement;
produce a third statement to output a position matching the extracted condition in the database and a fourth statement to apply the extracted content of the operation to the position of the database outputted by the third statement; and
apply the third statement and the fourth statement to the database in this order in applying the first statement.

6. The apparatus of claim 3, wherein
the processor is further configured to:
display a plurality of sets of first display information corresponding respectively to the plurality of operation requests in chronological order in which the plurality of operation requests are applied to the database; and
select one operation request from a set of operation requests which are determined to relate to the second operation request, specify another operation request which relates to the selected one operation request and is the closest to the one operation request, among the set of operation requests, and display second display information connecting a set of first display information among the plurality of sets of first display information that corresponds to the selected one operation request to a set of first display information among the plurality of sets of first display information that corresponds to the specified other operation request.

7. A method comprising:
providing a memory configured to store a plurality of operation requests to be applied to a database sequentially and a first output result outputted when the plurality of operation requests are applied to the database;
selecting a first operation request from among the plurality of operation requests;
acquiring contents of the database before the first operation request is applied;
producing a second output result which is outputted when a series of operation requests to be applied after the first operation request of the plurality of operation requests are applied to the acquired contents of the database, and
determining that when the first output result matches with the second output result, the first operation request does not relate to a second operation request which is applied last among the plurality of operation requests, wherein
the producing the second output result includes skipping an operation request which does not relate to the second operation request in the series of operation requests.

8. A non-transitory, computer-readable recording medium having stored therein a program for causing a computer to execute a process comprising:
providing a memory configured to store a plurality of operation requests to be applied to a database sequentially and a first output result outputted when the plurality of operation requests are applied to the database;
selecting a first operation request from among the plurality of operation requests;
acquiring contents of the database before the first operation request is applied;
producing a second output result which is outputted when a series of operation requests to be applied after the first operation request of the plurality of operation requests are applied to the acquired contents of the database; and
determining that when the first output result matches with the second output result, the first operation request does not relate to a second operation request which is applied last among the plurality of operation requests, wherein
the producing the second output result includes skipping an operation request which does not relate to the second operation request in the series of operation requests.
